(19) United States
(12) Patent Application Publication
(10) Pub. No.: US 2026/0210920 A1
(43) Pub. Date: Jul. 23, 2026

(54) DIGITALIZATION, AUTOMATION AND OPTIMIZATION OF TIME-LAPSE GEOCHEMISTRY (TLG) WORKFLOW TO OPTIMIZE DEVELOPMENT PLANS FOR UNCONVENTIONAL RESERVOIRS HAVING MULTIPLE PRODUCTION ZONES

(71) Applicant: ConocoPhillips Company, Houston, TX (US)

(72) Inventors: Xin Luo, Houston, TX (US); Ye Wang, Houston, TX (US); Brook C. Riley, Houston, TX (US); Bo Hu, Houston, TX (US); Jason Jweda, Houston, TX (US)

(21) Appl. No.: 19/456,290

(22) Filed: Jan. 22, 2026

Related U.S. Application Data
(60) Provisional application No. 63/748,551, filed on Jan. 23, 2025.

(51) Int. Cl. G01N 31/22; E21B 43/16

(52) U.S. Cl. CPC G01N 31/229; E21B 43/16

(57) ABSTRACT

Method of optimizing well placement in an unconventional reservoir, by obtaining a plurality of produced oil, produced water and produced gas samples from an unconventional reservoir over a period of time, and obtaining a plurality of rock samples from the reservoir. Each of those plurality of samples is chemically fingerprinted, as well as assigned time and location identifiers. This data is then used to generate a plurality of reservoir maps over time and those maps then used to optimize well placement in the reservoir.

### CROSS-REFERENCE TO RELATED APPLICATIONS

The present application claims priority to U.S. Provisional Patent Application No. 63/748,551 filed on Jan. 23, 2025, which is incorporated by reference in its entirety herein.

### FIELD OF THE DISCLOSURE

The disclosed methods relate generally to the optimal development plans in unconventional reservoir including well spacing and stacking, well development sequence, completion design, and landing target.

### BACKGROUND OF THE DISCLOSURE

Geologic formations may contain large quantities of oil or gas but can have a poor flow rate due to low permeability or from damage or clogging of the formation during drilling. This is particularly true for tight sands, shales, and coalbed methane formations. Hydraulic fracturing (aka fracking) requires the pumping of fluids under high pressure into reservoirs to create fractures in the rock, thus improving flow. Fracking thus stimulates wells drilled into such formations, making profitable what would otherwise be a prohibitively expensive process.

The combination of hydraulic fracturing with horizontal drilling has opened up shale deposits across the country and brought large-scale natural gas drilling to new regions. Shale deposits in combination with other unconventional resources such as, for example, heavy oil using steam assisted gravity drainage (SAGD) and cyclic steam stimulation (CSS) techniques, have allowed the economic production of a variety of unique reservoirs. Oil reserves that previously were thought commercially unfeasible to access are now being developed.

The optimal spacing and stacking of horizontal wells in unconventional field developments remains a major uncertainty because of the lack of information regarding the volume of rock being drained, sometimes referred to as drained rock volume (DRV). The drained rock volume is often less than the stimulated rock volume (SRV). If spacing in either the vertical or lateral dimension is too wide between horizontal wells, hydrocarbon resources are left behind, and if too close, wells compete for the same in-place resource. Economic value during unconventional field development may be significantly reduced by sub-optimal horizontal well spacing and stacking.

### SUMMARY OF THE DISCLOSURE

The disclosure describes a methodology that uses a cloud computing environment to efficiently execute time-lapse geochemistry (TLG) workflow that determines production allocation down to intra-formation level—not just between gross formation. Thus, the systems and methods described herein are able to quickly, accurately, and inexpensively determine the effective vertical drained rock volume over time from horizontal wells in an unconventional reservoir. This can then be used to determine production allocation, which can be used in reservoir modeling, to optimize well placement and thereby production of oil and recovery factors. For example, production allocations of the production zones (also referred to as end-members) are determined using compound/isotope ratios as chemical fingerprints/signatures to distinguish whence (or what percentage) of a production comes from the respective production zones. These fingerprints can be generated from continuance of the production, including, e.g., oil, water, and gas samples from the reservoir. By collecting the produced oil, water and gas samples over time and fingerprinting the samples, the source of the produced fluids can be quantitatively allocated to unique production zones. This provides a picture of how the intra-formation levels of the reservoir are evolving, which can be used to make more informed decisions about placement, completion, and utilization of wells how to optimally develop the reservoir. In summary, the TLG workflow allows the source of produced fluids to be quantitatively allocated to unique production zones, and cloud-based system effectively increasing work efficiency by reducing interpretation cycle from weeks to hours.

The effective rock drainage volume (DRV) of horizontal wells in unconventional reservoirs can be determined by analyzing and interpreting the geochemical signatures contained in produced fluids from those wells. Natural changes in geochemistry of in-situ gas and oil within the reservoir arise from differences in organic matter type, the kerogen kinetics, thermal maturity, hydrocarbon migration and/or local changes in conversion from catalytic effects. These differences in chemistry are often homogenized in conventional reservoirs over geological time from processes of density driven mixing and diffusion as a function of the strata porosity and permeability, strata temperature and pressure and fluid viscosity.

However, in very low permeability reservoirs <10⁻⁶ md, the homogenization process can take millions of years to occur over lateral distances of only hundreds of feet. Vertical mixing and homogenization can be further slowed by rock strata heterogeneity (i.e., tortuosity; low matrix permeability, inter bedded zones) to the point of setting up discrete chemical signatures vertically. Therefore, the reservoir ultimately may record a significant amount of both vertical and lateral geochemical heterogeneity. This geochemical heterogeneity represents temporal and spatial variability in organic facies, depositional conditions, and thermal maturity across and through the reservoir.

Advantageously, the heterogeneity herein can be used by comparing and linking the geochemical fingerprints of produced fluids to source characteristics of the rock drained in horizontal wells landed in multiple zones within the reservoir. These geochemical fingerprint differences by strata are confirmed from oil samples extracted from vertical rock samples (e.g., core/SWC or wet cutting). Geochemical signatures are used to determine the distance of drainage from the well-bore and thus determine the drained rock volume.

As used herein, a “reservoir” is a formation or a portion of a formation that includes sufficient permeability and porosity to hold and transmit fluids, such as hydrocarbons or water or natural gas, and the like. A reservoir can have a plurality of chemically distinct “zones” therein, particularly in very tight rock, where mixing is almost non-existent.

An “end-member” (also endmember or end member) in mineralogy is a mineral that is at the extreme end of a mineral series in terms of purity. In this context, it refers to reservoir intervals that are chemically distinct.

As used herein, “landing zone” refers to the location where the wells are placed in reservoirs.

As used herein, a “well-interference test” refers to pressure variation with time recorded in observation wells resulting from changes in rates in production or injection wells. In commercially viable reservoirs, it usually takes considerable time for production at one well to measurably affect the pressure at an adjacent well. Consequently, interference testing has been uncommon because of the cost and the difficulty in maintaining fixed flow rates over an extended period. With the increasing number of permanent gauge installations, interference testing may become more common than in the past.

As used herein, “SARA fractions” refers to the four fractions (%) of crude oil that can be separated, including saturates, aromatics, resins, and asphaltenes. SARA quantification is typically performed by IP-143 and ASTM D893-69 standards.

A “core” is a sample of rock in the shape of a cylinder. Taken from the side of a drilled oil or gas well, a core is then dissected into multiple core plugs, or small cylindrical samples measuring about 1 inch in diameter and 3 inches long.

“Drilling cuttings” are the small rock samples generated during drilling and returned with the drilling mud.

As used herein, “obtaining” a sample herein does not necessarily imply contemporaneous sampling procedures as existing samples can be used where available. However, most often, contemporaneous sample collection will be needed, except for core/SWC or wet cutting samples, which may already be available.

As used herein, generating a reservoir “map” refers to the reservoir being characterized in the three directional axes as well as the fourth time axis, but this does not necessarily imply a graphical representation thereof, as data can be maintained and accessed in many forms, including in tables.

The use of the word “a” or “an” when used in conjunction with the term “comprising” in the claims or the specification means one or more than one, unless the context dictates otherwise.

The term “about” means the stated value plus or minus the margin of error of measurement or plus or minus 10% if no method of measurement is indicated.

The use of the term “or” in the claims is used to mean “and/or” unless explicitly indicated to refer to alternatives only or if the alternatives are mutually exclusive.

The terms “comprise”, “have”, “include” and “contain” (and their variants) are open-ended linking verbs and allow the addition of other elements when used in a claim.

As used herein a “fingerprint” is an analysis of the chemical and/or isotopic components of a sample and is typically complex enough to uniquely identify the source of oil, gas, and water samples. “Fingerprinting” refers to the analyses needed to generate the fingerprints.

The component data can be a large data set, which under current processing limitations, is simplified for use. Herein, ratios of compounds are generated, and a subset of the generated ratios are selected based on the criterion that the selected ratios are relatively constant between core and production samples—e.g., the act of producing the samples did not change the data significantly. However, with sufficient processing power, other methods could be used.

The following abbreviations are used herein:

| ABBREVIATION | TERM |
|---|---|
| AAS | Atomic Absorbance Spectrophotometer |
| Bbl | Barrel |
| BVO | bulk volume oil |
| CE | capillary electrophoresis |
| DRV | Drained rock volume |
| EOR | Enhanced Oil Recovery |
| FTICR | Fourier Transform Ion Cyclotron Resonance |
| FTIR | Fourier Transform Infra-Red |
| HRGC | High Resolution Gas Chromatography |
| GCxGC- | 2D gas Chromatography time-of-flight mass |
| TOFMS | spectrometry |
| GR | Gamma ray |
| HPLC | High Pressure Liquid Chromatography |
| HPS | High pressure separator |
| IC | Ion Chromatography |
| ICP-MS | Inductively Coupled Plasma Mass Spectrometry |
| MB | Middle Bakken |
| MS | Mass Spectrometry |
| MTF | Middle Three Forks |
| NMR | Nuclear Magnetic Resonance |
| SARA | Saturates, Aromatics, Resins, Asphaltenes |
| SRV | Stimulated rock volume |
| TLC | thin layer chromatography |
| TLG | Time lapse geochemistry |
| USGS | US Geological survey |
| XRF | X-ray Fluorescence |
| MPLC | Medium Pressure Liquid Chromatography |

### BRIEF DESCRIPTION OF THE DRAWINGS

FIG. 1 illustrates an example of a network environment that includes a reservoir modeling system that uses time-lapse geochemistry (TLG), in accordance with certain implementations.

FIG. 2 illustrates an example of a cloud-computing environment that executes a TLG workflow and is accessible to users via a network, in accordance with certain implementations.

FIG. 3 illustrates a block diagram for an example of reservoir modeling/optimization workflows that uses TLG, in accordance with certain implementations.

FIG. 4 illustrates a flow diagram for an example of a method that uses TLG to allocate production and uses the allocated production to optimize reservoir performance, in accordance with certain implementations.

FIG. 5 illustrates a plot in which two example diagnostic biomarker ratios that separate time series production for wells, in accordance with certain implementations.

FIG. 6 illustrates a plot in which example compound ratios provide stratigraphic information, in accordance with certain implementations.

FIG. 7 illustrates an example of using hierarchical cluster analysis (HCA) on a set of common ratios to select a subset of the ratios as fingerprints, in accordance with certain implementations.

FIG. 8 illustrates plots and analysis for an example discrete end-member matrix with two end-members, in accordance with certain implementations.

FIG. 9 illustrates an example of separating capacity with respect to depth being plotted for multiple ratios, i.e., R1, R2, R3, and R4, in accordance with certain implementations.

FIG. 10 illustrates an example of a well log from the pilot-hole well, in accordance with certain implementations.

FIG. 11 illustrates an example of a cross-section showing the locations of various wells, in accordance with certain implementations.

FIG. 12 illustrates cross-plot of example chemical signatures of produced fluids of oil, gas, and water, in which the chemical signatures are plotted as a function of depth and component ratios, in accordance with certain implementations.

FIG. 13 illustrates cross-plot of example chemical signatures of end-member water compared to produced water, in accordance with certain implementations.

FIG. 14 illustrates a plot showing the separation between MB and TF intervals using two biomarker ratios in a produced oil sample, in accordance with certain implementations.

FIG. 15 illustrates bar graphs showing an example 12-month production allocation results of produced oil, in accordance with certain implementations.

FIG. 16 illustrates a plot of example micro-seismic events as a function of depth, in accordance with certain implementations.

FIG. 17 illustrates a flow diagram for a method that uses TLG to allocate production and uses the allocated production to optimize reservoir performance, in accordance with certain implementations.

FIG. 18 illustrates a system for cloud computing, in accordance with certain implementations.

FIG. 19 illustrates a plot of data points for ratio selection.

### DESCRIPTION OF EXAMPLE IMPLEMENTATIONS

Various implementations of the disclosure are discussed in detail below. While specific implementations are discussed, it should be understood that this is done for illustration purposes only. A person skilled in the relevant art will recognize that other components and configurations may be used without parting from the spirit and scope of the disclosure.

### Overview

In some aspects, the techniques described herein relate to a method of allocating production, including: storing, at a cloud-computing platform, component data representing chemical attributes measured for samples from respective production zones of one or more reservoirs, wherein the component data includes oil data, water data, and gas data, and the component data includes respective parts corresponding to measurements of samples; associating the respective parts the component data with times and locations at which the samples are collected; selecting, at the cloud-computing platform and based on the component data, at least one compound ratio or isotope ratio that uniquely identifies from which of the respective production zones a produced fluid originates, thereby enabling an analysis of a mixture of produced fluids originating from the respective production zones that determines production allocations from the respective production zones; storing, at the cloud-computing platform, time-series data representing chemical attributes measured at a series of times for productions from a well; analyzing, at the cloud-computing platform, the time-series data using the at least one compound ratio or isotope ratio to determine production intervals by estimating respective contributions of the productions corresponding to the respective production zones.

In some aspects, the techniques described herein relate to a method, further including sharing, via the cloud-computing platform and among a plurality of users, access to the component data, the time-series data, analysis tools used in selecting the at least one compound ratio or isotope ratio and/or analyzing the time-series data of the productions using the at least one compound ratio or isotope ratio.

In some aspects, the techniques described herein relate to a method, further including: using a cloud-based application to process the component data by analyzing a plurality of ratios including non-normalized (AB) ratios and normalized (A/A+B) ratios of all possible compound ratios ranking ratios according to a square of Pearson correlation, wherein a ratio is selected as a candidate for the at least one compound ratio or isotope ratio if the ratios satisfies criteria of i) the ratio is generally constant between rock samples and the productions, ii) each compound in the ratio follows linear mixing rules, and iii) the ratio provide separation from drilling mud ratios.

In some aspects, the techniques described herein relate to a method, further including using the cloud-based application to process the time-series data of the productions using the at least one compound ratio or isotope ratio to determine the production intervals.

In some aspects, the techniques described herein relate to a method, wherein: the component data includes chemical signatures measured from rock samples collected from the respective production zones, the time-series data includes the chemical signatures measured from the productions and the at least one compound ratio or isotope ratio are ratios of compounds that are generally constant for both the rock samples and the productions.

In some aspects, the techniques described herein relate to a method, wherein: the productions include a hydrocarbon resource produced from the well, the at least one compound ratio or isotope ratio is selected based on providing sufficient separation to distinguish a first produced fluid of a first production zone from a second fluid of a second production zone, and the at least one compound ratio or isotope ratio are selected from hydrocarbon compound ratios, aromatic biomarker ratios, isotope ratios, gas compositional ratios, and water isotope ratios.

In some aspects, the techniques described herein relate to a method, wherein analyzing the time-series data to determine the production intervals by estimating the respective contributions to the productions corresponding to the respective production zones includes calculating:

$${p}_{i} = {\sum }_{j = 1}^{m} {r}_{i} , {w}_{j} , where i = 1 , 2 , … n and n \geq m , and$$

$${\sum }_{j = 1}^{m} {w}_{j} = 1 , where 0 \leq {w}_{j} \leq 1 ,$$

wherein wⱼ is a production allocation of a j^{th} production zone, r_{i,j} is a biomarker ratio value corresponding to the j^{th} production zone and an i^{th} biomarker ratio, and pᵢ is an aggregated value of the i^{th} biomarker ratio, wherein values of the production allocations wⱼ are optimized subject to t

$${\sum }_{j = 1}^{m} {w}_{j} = 1$$

to generate aggregated values of the biomarker ratios pᵢ that most closely match measured values of the at least one compound ratio or isotope ratio for the produced samples.

In some aspects, the techniques described herein relate to a method, wherein optimizing the values of the production allocations wⱼ to generate the aggregated values pᵢ that most closely match measured values of the at least one compound ratio or isotope ratio for the productions includes minimizing a mismatch function between produced values of the biomarker ratios pᵢ and predicted values of the biomarker ratios pᵢ, and the mismatch function is selected from the group consisting of a least squares mismatch function, a least square with range correction mismatch function, a Cauchy mismatch function, a Cauchy with range correction mismatch function, and a range corrected absolute difference mismatch function.

In some aspects, the techniques described herein relate to a method, further including: determining a placement or a completion of another well using the production intervals.

In some aspects, the techniques described herein relate to a cloud-computing apparatus including: one or more processors; and one or more memories storing instructions, component data, and time-series data, wherein the component data represents chemical attributes measured for samples from respective production zones of one or more reservoirs, wherein the component data includes oil data, water data, and gas data, and the component data includes respective parts corresponding to measurements of samples, the time-series data represents chemical attributes measured at a series of times for productions from a well, and the instructions, when executed by the one or more processors, configure the cloud-computing apparatus to: associate the respective parts the component data with times and locations at which the samples are collected; select, based on the component data, at least one compound ratio or isotope ratio that uniquely identifies from which of the respective production zones a produced fluid originates, thereby enabling an analysis of a mixture of produced fluid originating from the respective production zones that determines production allocations from the respective production zones; and analyze the time-series data using the at least one compound ratio or isotope ratio to determine production intervals by estimating respective contributions of the productions corresponding to the respective production zones.

In some aspects, the techniques described herein relate to a cloud-computing apparatus, wherein the instructions further configure the cloud-computing apparatus to: share, among a plurality of users, access to the component data, the time-series data, analysis tools used in selecting the at least one compound ratio or isotope ratio and/or analyzing the time-series data of the productions using the at least one compound ratio or isotope ratio.

In some aspects, the techniques described herein relate to a cloud-computing apparatus, wherein the instructions further configure the cloud-computing apparatus to: use a cloud-based application to process the component data by analyzing a plurality of ratios including non-normalized (AB) ratios and normalized (A/A+B) ratios of all possible compound ratios ranking ratios according to a square of Pearson correlation, wherein a ratio is selected as a candidate for the at least one compound ratio or isotope ratio if the ratios satisfies criteria of i) the ratio is generally constant between rock samples and the productions, ii) each compound in the ratio follows linear mixing rules, and iii) the ratio provide separation from drilling mud ratios.

In some aspects, the techniques described herein relate to a cloud-computing apparatus, wherein the instructions further configure the cloud-computing apparatus to: use the cloud-based application to process analyzing, to analyze the time-series data of the productions using the at least one compound ratio or isotope ratio to determine the production intervals.

In some aspects, the techniques described herein relate to a cloud-computing apparatus, wherein: the component data includes chemical signatures measured from rock samples collected from the respective production zones, the time-series data includes the chemical signatures measured from productions, and the at least one compound ratio or isotope ratio are ratios of compounds that are generally constant for both the rock samples and the productions.

In some aspects, the techniques described herein relate to a cloud-computing apparatus, wherein analyzing the time-series data to determine the production intervals by estimating the respective contributions to the productions corresponding to the respective production zones includes calculating:

$${p}_{i} = {\sum }_{j = 1}^{m} {r}_{i} , {w}_{j} , where i = 1 , 2 , … n and n \geq m , and$$

$${\sum }_{j = 1}^{m} {w}_{j} = 1 , where 0 \leq {w}_{j} \leq 1 ,$$

wherein wⱼ is a production allocation of a j^{th} production zone, r_{i,j} is a biomarker ratio value corresponding to the j^{th} production zone and an i^{th} biomarker ratio, and pᵢ is an aggregated value of the i^{th} biomarker ratio, wherein values of the production allocations wⱼ are optimized subject to t

$${\sum }_{j = 1}^{m} {w}_{j} = 1$$

to generate aggregated values of the biomarker ratios pᵢ that most closely match measured values of the at least one compound ratio or isotope ratio for the produced samples.

In some aspects, the techniques described herein relate to a cloud-computing apparatus, wherein optimizing the values of the production allocations w_{f} to generate the aggregated values pᵢ that most closely match measured values of the at least one compound ratio or isotope ratio for the productions includes minimizing a mismatch function between produced values of the biomarker ratios pᵢ and predicted values of the biomarker ratios pᵢ, and the mismatch function is selected from the group consisting of a least squares mismatch function, a least square with range correction mismatch function, a Cauchy mismatch function, a Cauchy with range correction mismatch function, and a range corrected absolute difference mismatch function.

In some aspects, the techniques described herein relate to a cloud-computing apparatus, wherein the instructions further configure the cloud-computing apparatus to: determine a placement or a completion of another well using the production intervals.

In some aspects, the techniques described herein relate to a non-transitory computer-readable storage medium, the computer-readable storage medium including instructions that when executed by a computer, cause the computer to: store, at a cloud-computing platform, component data representing chemical attributes measured for samples from respective production zones of one or more reservoirs, wherein the component data includes oil data, water data, and gas data, the component data including respective parts corresponding to measurements of samples; associate the respective parts the component data with times and locations at which the samples are collected; select, at the cloud-computing platform and based on the component data, at least one compound ratio or isotope ratio that uniquely identifies from which of the respective production zones a produced fluid originates, thereby enabling an analysis of a mixture of produced fluid originating from the respective production zones that determines production allocations from the respective production zones; store, at the cloud-computing platform, time-series data representing chemical attributes measured at a series of times for productions from a well; and analyze, at the cloud-computing platform, the time-series data using the at least one compound ratio or isotope ratio to determine production intervals by estimating respective contributions of the productions corresponding to the respective production zones.

In some aspects, the techniques described herein relate to a non-transitory computer-readable storage medium, wherein the instructions further cause the computer to: use a cloud-based application to process the component data by analyzing a plurality of ratios including non-normalized (AB) ratios and normalized (A/A+B) ratios of all possible compound ratios ranking ratios according to a square of Pearson correlation, wherein a ratio is selected as a candidate for the at least one compound ratio or isotope ratio if the ratios satisfies criteria of i) the ratio is generally constant between rock samples and the productions, ii) each compound in the ratio follows linear mixing rules, and iii) the ratio provide separation from drilling mud ratios.

In some aspects, the techniques described herein relate to a non-transitory computer-readable storage medium, wherein the instructions further cause the computer to: use a cloud-based application to process analyzing, to analyze the time-series data of the productions using the at least one compound ratio or isotope ratio to determine the production intervals.

### EXAMPLE IMPLEMENTATIONS

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

The disclosed technology addresses the need in the art for more efficient time-lapse geochemistry (TLG) workflows. For example, conventional workflows are time consuming, inaccurate, and subject to code failures, resulting in a drained rock volume (DRV) estimation process that can be disjointed and confusing due to a lack of integration between steps. Moreover, different file formats and storage locations also impose challenges for documenting and sharing the TLG results/interpretation.

Accordingly, the systems and methods disclosed herein provide an integrated workflow in which the data, methods, and results are all integrated into a central, cloud-based platform. This workflow integration provides several benefits. This workflow integration enhances work efficiency and quality. For example, transitioning workflows from Excel to a cloud platform enables optimization of data analytics at respective steps within the workflow. The cloud-based workflow integration promotes transparency by increasing the visibility and consistency of TLG workflows. The cloud-based platform enables multiple users to participate in the process and reduces barriers to sharing results. In addition, the cloud-based platform enables continuous optimization as a collaborative effort between geochemistry and data science.

TLG provides an effective technology for evaluating drained rock volume (DRV) for unconventional reservoirs to help optimize well spacing and stacking, well development sequencing, completion design, and landing target.

The systems and methods disclosed herein provide an integrated TLG workflow that uses a cloud platform accommodating optimal artificial intelligence (AI) workflows and automation processes for DRV analysis. The systems and methods disclosed herein increase work efficiency while assuring work quality. The systems and methods disclosed herein promote transparency of TLG workflows. The systems and methods disclosed herein provide seamless sharing of data, results, and interpretations. The systems and methods disclosed herein enable collaboration among experts. According to certain non-limiting examples, the systems and methods disclosed herein document the workflow process to allow sharing with peers. According to certain non-limiting examples, the systems and methods disclosed herein interpretation workflows are automated for data collected at a later time.

According to certain non-limiting examples, the systems and methods disclosed herein provide a unified analytics environment. Further, the systems and methods disclosed herein provide advanced data analytics models for each step from data access, geochemical ratio generation and selection, DRV calculation, DRV plots, to integration with petrophysical data. The systems and methods disclosed herein enable digitalization, automation, and optimization of geochemical work processes within a unified analytics environment.

As discussed above in the BRIEF SUMMARY, the heterogeneity in geologic formations can be used by comparing and linking the geochemical fingerprints of produced fluids to source characteristics of the rock drained in horizontal wells landed in multiple zones within the reservoir. These geochemical fingerprint differences by strata are confirmed from oil samples extracted from vertical core samples. Geochemical signatures are used to determine the distance of drainage from the well-bore and thus determine the drained rock volume.

According to certain non-limiting examples, production is allocated in a plurality of reservoirs by obtaining rock samples from different zones in the reservoir(s) and chemically fingerprinting extracts from the rock samples; obtaining produced oil, produced water, and produced gas samples from one or more reservoirs over time; chemically fingerprinting the samples to provide oil fingerprints, water fingerprints, and gas fingerprints; assigning a time and location the oil, water, and gas fingerprints; and allocating production from one or more wells in relation to the time and location of the fingerprints.

In another implementation, well placement is optimized in a reservoir, by obtaining rock samples from different zones of the reservoir(s); chemically fingerprinting extracts from the rock samples to provide rock fingerprints; grouping the zones into unique production zones by determining unique fingerprints; obtaining a plurality of produced oil, produced water and produced gas samples from the reservoir(s) over a period; chemically fingerprinting the samples to provide oil fingerprints, water fingerprints, and gas fingerprints; assigning a time and location identifier to each of the oil, water, and gas fingerprints; determining which of the samples originate from which production zone by comparison to the unique fingerprints and determining a level of mixing according to the following equations:

$${p}_{i} = {\sum }_{j = 1}^{m} \sum {r}_{i , j} , {w}_{j} ( i = 1 … n ) where n \geq m , and$$

$${\sum }_{j = 1}^{m} {w}_{j} = 1 , where 0 \leq {w}_{j} \leq 1 ,$$

inputting data from the unique production zones and the level of mixing into a reservoir modeling program; optimizing well placement using the reservoir modeling program; and implementing the optimized well placement in the reservoir(s).

In an additional implementation, production is allocated in an unconventional reservoir, by: obtaining rock samples from different zones in an unconventional reservoir(s); chemically fingerprinting extracts from the rock samples to provide rock fingerprints; grouping the fingerprints into unique production zones; obtaining produced oil, produced water, and optionally produced gas samples from one or more zones of an unconventional reservoir(s) over time; chemically fingerprinting the samples to provide one or more oil, water, and gas fingerprints; where the component data is simplified by generating ratios of all possible compound ratios, and selecting a ratio for use if the ratio is generally constant, and each compound in the ratio follows linear mixing rules; determining which portion of the samples originate from which production zone(s) by comparison to the unique fingerprints and determining a level of mixing according to linear algebraic equations, and determining which unique zone contributes to production of oil, gas and water samples and how much.

The fingerprints comprise ratios of compounds that are generally constant between rock samples and produced samples. Each compound in a ratio generally follows linear mixing rules. The raw fingerprinting data may be fed into a macro that builds non-normalized (AB) and normalized (A/A+B) ratios of all possible compound ratios and then ranks ratios using a square of Pearson correlation, where a ratio is selected for use in the method if the ratio is generally constant between rock samples and produced samples, and each compound in the ratio follows linear mixing rules, and the ratio is clearly separate from drilling mud ratios. In an implementation, the ratio is generated from HRGC and GC-MS compounds separately by one or more computing programs executed by the one or more processors 218. This can allow for at least ten-thousand ratios generated between geochemical compounds (AB ratios or A/(A+B) ratios).

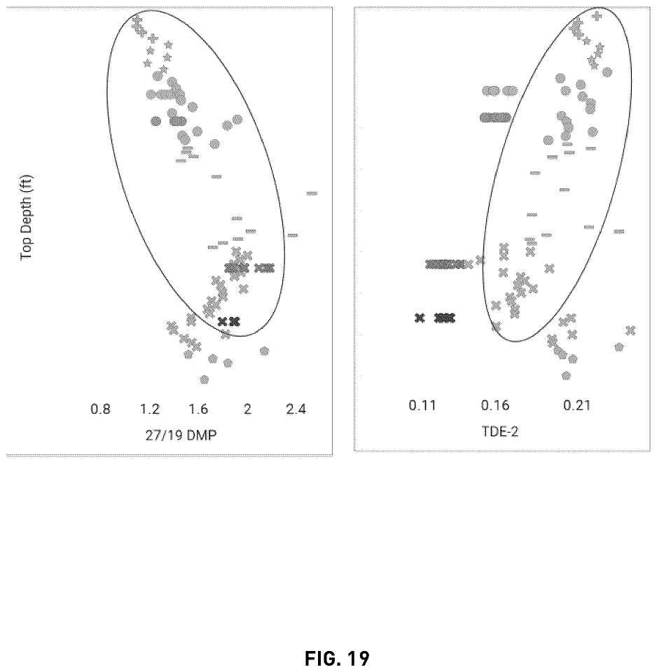

In an implementation, optimized ratio selection is performed using an AI-based workflow. In this implementation, landing target depths for production wells relative to end-member wells are assigned. The geochemical ratio for compounds with similar physical and chemical properties are calculated and normalized to highlight distinct patterns for each reservoir or interval. The geochemical ratios are ranked based on statistical analysis (e.g., Pearson correlations). This allows for identifying specific data points that fall within a standard deviation range, which are represented by the red ellipse on the plot illustrated in FIG. 19. The red ellipse represents a 95% confidence interval based on the standard deviation. Therefore, if the data follows a normal distribution, 95% of the data points are expected to fall within the ellipse. The ratios having produced sample data points residing in the eclipse will be selected and ranked. Conversely, the ratios with produced sample data points outside of the ellipse will be removed from consideration. Programs executed in the cloud-based platform can automatically use this workflow to quickly select and rank geochemical ratios for DRV calculations.

Location information may include depth and lateral placement (x, y, and z axes). A reservoir map may be generated in the form of tables including component data organized by location (x, y, and z axes) and time.

Chemical fingerprinting may use GC, MS, GC-MS, FTICR-MS, TLC, 2D TLC, CE, HPLC, FTIR Spectrophotometry, XRF, AAS, ICP-MS, IC, NMR, GCxGC-TOFMS, SARA, CHNOS analysis, elemental analysis, GC/IR-MS, or any combination. In one implementation, chemically fingerprinting step uses GC-MS. In another implementation, the ratio of gasoline compounds, biomarkers, gas compositions, water isotopes, and the like may be used. In another implementation, water fingerprints like chlorine, bromine, strontium, water deuterium, water oxygen, sulfur, iron, and the like may be used. In yet another implementation, gas fingerprints may include carbon (13), sulfur (34), methane, ethane, propane, butane, pentane, H2S, and the like. Alternatively, fingerprints may include API gravity, elemental composition, saturate levels, aromatic levels, resin levels, and asphaltene levels (SARA) fractions.

According to certain non-limiting examples, the systems and methods disclosed herein uses the geochemical fingerprints of produced oil and gas samples from horizontal wells collected over time. Automated generation and screening for the thousands of possible ratios (compounds and isotopes) that provide information by stratigraphic interval is facilitated by automated analysis using a cloud-based application. Compound ratios are screened based on concentration for adherence to linear mixing rules, for consistency between extracted and produced sample, as well as for compounds/ratios whose variance is above analytical variation. The basis of quantitative production allocation are matrix linear algebra solutions with modification to handle large matrices and explore uncertainty around a non-unique solution.

According to certain non-limiting examples, during hydrocarbon production on horizontal wells, produced samples (oil, gas, water) are collected from the high-pressure separator (HPS) at regular time intervals. Production details (e.g., daily rates, yields) and wellhead/separator conditions are recorded at the time of sample collection.

According to certain non-limiting examples, existing or new core samples or drill cuttings can be collected, extracted and analyzed. These are used to establish the chemical fingerprints of chemically distinct zones in the reservoir(s), and these end-member fingerprints are used to determine when mixing is occurring, from which zones, and how much.

According to certain non-limiting examples, samples are collected over time and are intended to capture produced fluid variability at the beginning of production occurring due to initial connectivity between fracture networks. Since fracture connectivity is thought to decrease with reduced pressure as drawdown proceeds and fractures close under the reduced pressure, a slower sampling rate can be used later in well life. Although the rate of sampling may slow, it is beneficial to continue monitoring fluids at a regular interval in order to capture changes in the drainage system and any hydrocarbon phase property variability through time.

According to certain non-limiting examples, produced fluids can be analyzed for a variety of bulk and geochemical parameters to establish the produced fluid fingerprints. Routine analyses for produced gas samples include gas compositions and carbon (13) isotopes (methane-pentane), as well as H₂S and sulfur (34) isotopes in the case of the Eagle Ford. However, these analyses are exemplary only and many other methods of generating fingerprints could be used.

According to certain non-limiting examples, bulk oil parameters include API gravity, elemental compositions, and Saturates, Aromatics, Resins, Asphaltenes (SARA) fractions. Detailed oil analyses for composition and biomarkers include whole oil-GC, aromatics-GC-MS, and saturates-GC-MS. The required analytical program may vary between plays and perhaps for different parts of a play, but typically a standard set of analysis in a given region will be used. Further, these particular analyses are exemplary only and other analytical methods can be used to generate fingerprints for the systems and methods disclosed herein.

According to certain non-limiting examples, time-series reservoir geochemistry can be used in concert with production, microseismic, and tracer data in an unconventional asset to determine effective drainage heights and production allocation. In one implementation, time-series reservoir geochemistry is analyzed using a spatial mapping on the x, y, and z axes in a known reservoir. Additionally changes over time may be monitored.

There are several advantages to using the time-series reservoir geochemistry technology relative to other methodologies, such as injected tracers, micro-seismic event distribution, pressure monitoring and mechanical flow monitoring.

First, time-series reservoir geochemistry is inexpensive relative to the other methods. Geochemical monitoring of a single well monitoring (depending on the duration and type of analytical program) is approximately $50-80K US/well per year, whereas other methods cost upwards of $50-500K US/well per year.

Second, this type of monitoring is also advantageous in that produced fluid sampling does not burden or delay rig schedules and can be flexible with production maintenance. Thus, it is not inconvenient to deploy the method.

Third, geochemical compositions are fingerprints of the actual produced hydrocarbons. The time-series reservoir geochemistry method is therefore not a remote sensing based technology, but a direct measurement technology. It can thus be used quantitatively in determining vertical and horizontal effective drainage lengths and how it can vary over time.

Ratios used herein include nonnormalized AB and normalized A/(A+B), (A−B) and may include compound ratios.

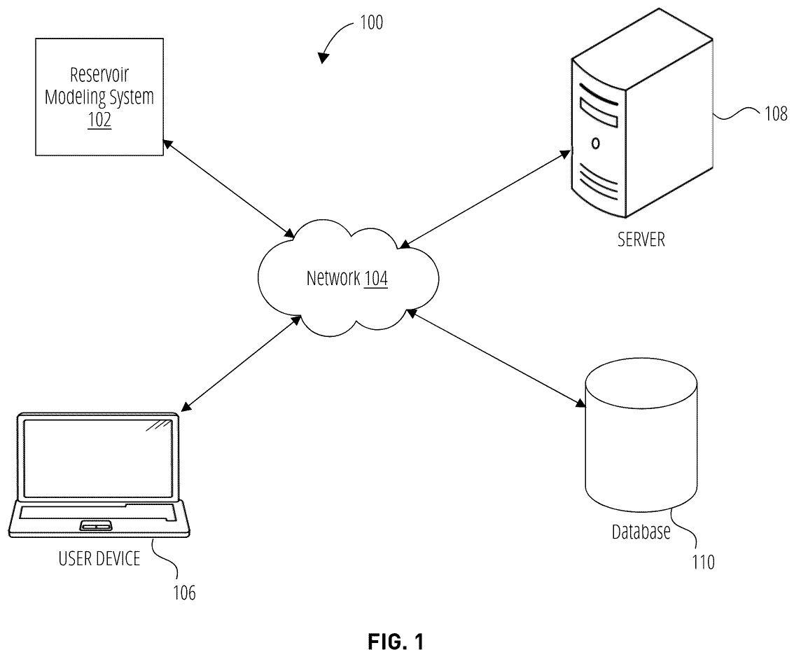

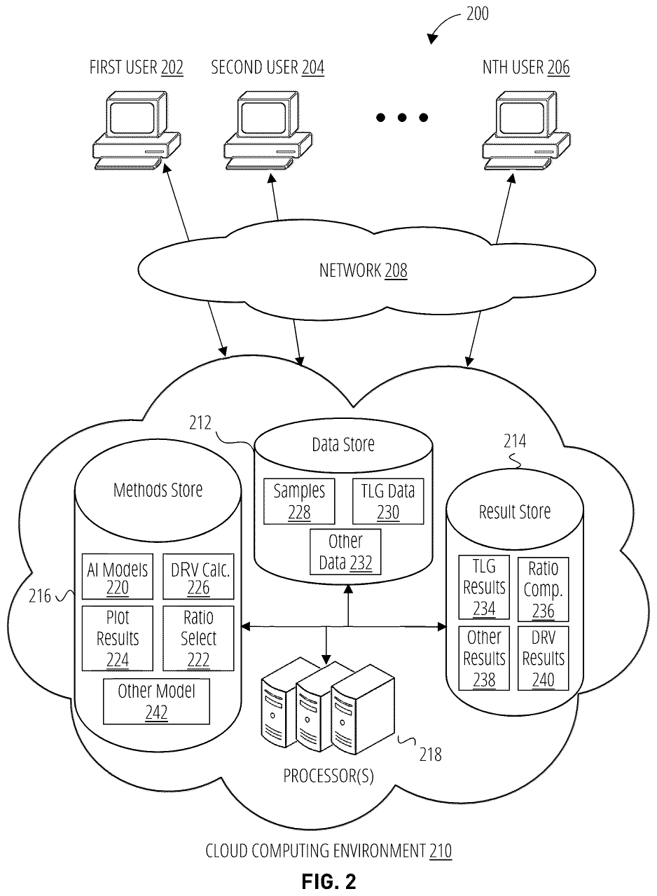

To begin a detailed discussion of an example system for modeling production for a well extracting a resource (e.g., oil and/or natural gas), reference is made to FIG. 1, which illustrates an example network environment 100 for implementing the various systems and methods, as described herein including a reservoir modeling system 102. As depicted in FIG. 1, a network 104 is used by one or more computing or data storage devices for implementing a reservoir modeling system 102 to generate one or more resource production models (e.g., DRV calculation model 226 and other models 242, which are illustrated in FIG. 2). In one implementation, various components of reservoir modeling system 102, user devices 106, databases 110, and/or other network components or computing devices described herein are communicatively connected to network 104. Examples of the user devices 106 include a terminal, personal computer, a smart-phone, a tablet, a mobile computer, a workstation, and/or the like.

A server 108 may, in some instances, host the system. In one implementation, server 108 also hosts a website or an application that users may visit to access network environment 100, including reservoir modeling system 102. The server 108 may be one single server, a plurality of servers with each such server being a physical server or a virtual machine, or a collection of both physical servers and virtual machines. In another implementation, a cloud hosts one or more components of the system. Reservoir modeling system 102, user devices 106, server 108, and other resources connected to network 104 may access one or more additional servers for access to one or more websites, applications, web services interfaces, etc. that are used for generating predications of well production.

FIG. 2 illustrates system 200 in which a cloud computing environment 210 that uses time lapse geochemistry (TLG) to analyze and predict well production. When production from a given well draws from multiple sources (e.g., different layers of shale oil deposits that are accessed via hydraulic fracturing), TLG uses chemical fingerprints (e.g., a biomarker ratio) of the respective sources (also referred to as end-members) to determine which fractions of the total production are drawn from which sources (also referred to as production intervals of the end-members). Different source can be depleted at different rates and knowing the production intervals of the end-members and how they change over time can help to predict future production from the well and to predict optimal placement and implementation for future wells.

FIG. 2 shows a several users (e.g., first user 202, second user 204, through Nth users 206) accessing cloud computing environment 210 via network 208. Cloud computing environment 210 includes data store 212, result store 214, and methods store 216, which can be located on a same database, located on different databases, or a combination thereof. As discussed below providing the methods, data, and results in a cloud environment has benefits for sharing data and results, enabling multiple users to work on the same TLG/resource analysis, and provide increased transparency and efficiency for the TLG/resource analysis. These methods can be performed by loading instructions corresponding to the methods into processor(s) 218 and applying data from data store 212 to the methods to thereby generates results that are stored in result store 214.

As discussed below, the systems and methods disclosed herein use various methods to analyze measurements from the region of a reservoir. These methods can include artificial intelligence (AI) models (e.g., AI models 220), fingerprint selection methods (e.g., fingerprint/ratio selection 222) DRV calculation model 226, and other model 242, which can be stored in methods store 216. Methods store 216 can also include other tools that aid in the TLG analysis, such as result visualization methods 224.

Further, the methods in methods store 216 can be applied to the data in data store 212, which can include samples data 228, TLG data 230, and other data 232. By applying the data from data store 212 to the methods of methods store 216 various results can be generated, which are stored in result store 214. The results in 214 can include TLG results 234, ratio components 236, other results 238, and DRV results 240.

For example, samples data 228 can include measurements of rock samples from different zones in the reservoir(s). For example, rock samples can be obtained from different geological layers corresponding to the respective end-members. Additionally, samples data 228 can include oil, water and gas samples. Oil, gas and water extracted from core samples or drill cuttings are also used, providing definitive geological placement for particular fingerprints. Some of these samples may already be available, and others can be generated at drilling. The collected samples can be labeled as to type and also time of collection and precise location. This data is then used in data analysis.

The samples are then analyzed by one or more methods to provide accurate fingerprints of the contents. The methods herein have been illustrated using the nonlimiting example of GC-MS, but any methods or combinations of methods can be used, including Gas Chromatography (GC), Mass Spectrometry (MS), GC-MS, thin layer chromatography (TLC), including 2D TLC, capillary electrophoresis (CE), High-Pressure Liquid Chromatography (HPLC), Fourier Transform Infra-Red (FTIR) Spectrophotometer, X-ray Fluorescence (XRF), Atomic Absorbance Spectrophotometer (AA or AAS), Inductively Coupled Plasma Mass Spectrometry (ICP-MS), Ion Chromatography (IC), Nuclear Magnetic Resonance (NMR), two-dimensional gas chromatography time-of-flight mass spectrometry (GCxGC-TOFMS), Fourier Transform Ion Cyclotron Resonance mass spectrometry (FTICR-MS), and the like. Additional analysis can include gas compounds, isotopes, bulk oil parameters (API Gv, SARA, CHNOS, elemental), whole oil-GC, aromatics-GC-MS (biomarkers), and the like. These results are stored in samples data 228.

Fingerprint/ratio selections 222 are performed on samples data 228 to determine which geochemical signatures provide separation for the respective end-members, such that they can be used to identify the intervals of production originating from the respective end-members. As discussed below, geochemical fingerprinting is possible when the composition of oil in each reservoir, or zones thereof, is different. In that case, when oils produced from discrete zones are commingled, subtle chemical differences in a produced oil sample can be used to assess the contribution from each pay zone. This technique uses high-resolution gas chromatography (GC) data obtained on each oil sample and also uses the availability of samples of each “end-member” oil that contributes to the production stream. GC peak heights, which reflect the abundance of each compound, can be used to allocate commingled production using linear algebra methods. FIG. 19 illustrates a plot of data points for ratio selection.

The results from fingerprint/ratio selection 222 can be stored in ratio components 236. ratio components 236 are then used to perform a TLG analysis.

TLG data 230 includes samples that are collected over time and include produced oil, gas, water, as well as isotraps for S-isotopes, Draeger tubes for H₂S and CO2, and the like. It may be beneficial in some cases to subtract injected water fingerprints from produced water fingerprints to distinguish in situ (core) water signatures from injected water.

For TLG analysis, samples can be collected at timed intervals, such as 1 sample/week for the first 3 months, 2 samples/month for the second 3 months, and 1 sample/month for another 6 months. These intervals are non-limiting examples, and sample collection can proceed for many years. These samples that are collected with respect to time from the resource production of the well can be stored in TLG data 230.

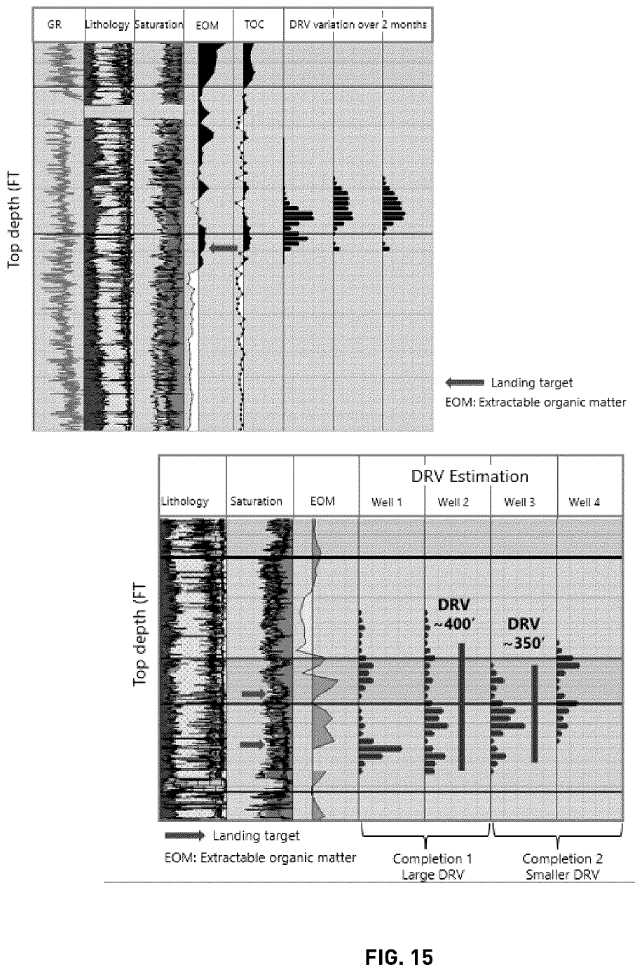

Using the selected biomarker ratios to form fingerprint/ratio selection 222 and the TLG data 230, TLG analysis can be used to determine production intervals as a function of time for the respective end-members, as illustrated in FIG. 15. The results of the TLG analysis can be stored in TLG results 234 and used for a drained rock volume (DRV) calculation or estimation process.

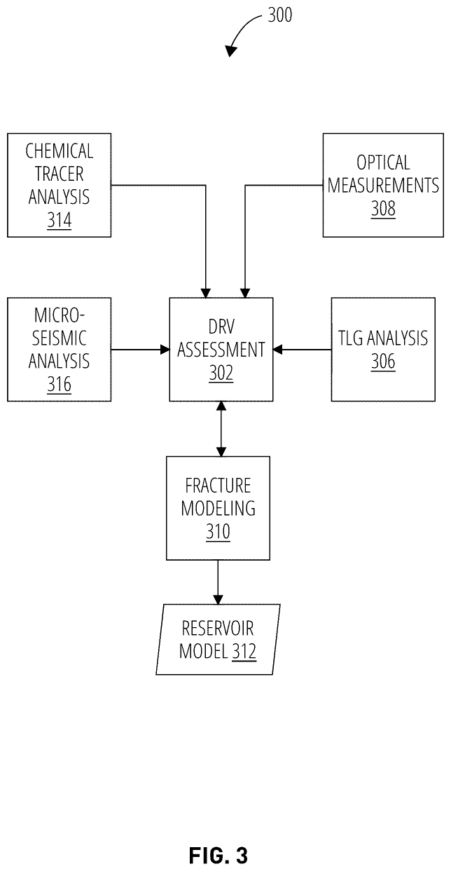

Other models 242 and other data 232 can also be used to perform additional analysis of the reservoir that can augment the TLG results 234 for predicting the performance of the well. For example, as illustrated in FIG. 3, the TLG results 234 can be combined with other results applied to DRV calculation model 226 to generate DRV results 240. Other models 242 can include, e.g., analysis using optical measurements 308, chemical tracer analysis 314, and/or micro-seismic analysis 316.

FIG. 3 illustrates an example of an integrated workflow for DRV calibration using subsurface information. For example, FIG. 3 schematically illustrates how TLG data can be incorporated in the integrated workflow and how the results from the TLG data can be used in the decision-making process for asset/well development.

In many cases, not all of the analyses shown in workflow 300 in FIG. 3 are available for DRV assessment 302. For example, in some cases one or more of optical measurements 308, chemical tracer analysis 314, or micro-seismic analysis 316 may not be possible because the requisite measurements for the analysis are not available for that case. That is, DRV assessment 302 can be performed using only the results of TLG analysis 306.

Chemical tracer analysis 314 can include introducing chemical tracers into one well by pumping the chemical tracers into the one well via flow back. Then samples of a neighboring well can be analyzed to detect the chemical tracer. Injected tracers are useful for addressing which stages of the completion are contributing to hydraulic fluid flow but have a limited utility life as the tracer is either absorbed to strata or their concentration depletes over time.

Micro-seismic analysis 316 can be used for determining fracture patterns and densities during hydraulic fracturing processes. These events provide a glimpse into rock behavior and the spatial extent of fracturing. There is, however, no straightforward method of determining based on only micro-seismic events an amount and degree of hydrocarbon fluid flow. As with injected tracers, micro-seismic monitoring only provides partial information of the initial subsurface environment prior to production.

Optical measurements 308 can be performed, e.g., using a carbon rod conveyed fiber optic to provide in-bore spectroscopic information of the well.

One limitation of the geochemistry-based methodology is the need to identify the distinct chemical signatures of end-members, which is not always available. The ability to extrapolate the end-members from core-extracted oil is limited also to a certain distance from the core. Thus, there may be a benefit to obtaining better core samples, at some expense, to fully realize the value of this methodology. However, drilling cuttings may also provide useful data and are readily available at every rig site.

TLG data can also be utilized qualitatively. This opens the potential for less expensive analytical tools (e.g. GC vs. GC-MS) and sometimes easier data processing. Qualitative methods can take advantage of the use of gasoline range compounds from GC, as illustrated in FIG. 3. This is advantageous because qualitative methods that use gasoline range compounds from GC are highly reproducible, in contrast to using core extracts. For example, many of the geochemical signals that are recorded and confirmed to carry valid zone separation information from core extracts can be confirmed in the produced oils, but due to differences in compound concentrations by zone and fractionation during production, are not useful for quantification.

Various methodologies, such as micro-seismic monitoring during the hydraulic fracturing process and monitoring pressure and injected tracers during production, can be used to evaluate wellbore communication and fracture network connectivity. These measurements are helpful but provide incomplete information for understanding reservoir drainage.

There are a number of proxy solutions aimed at understanding the SRV through the utilization of injected tracers in frack fluids, micro-seismic event distributions, and production metrics and pressure data between wells. These solutions are based on assumptions that rely on rock behavior during completion and production processes. Notably, the SRV does not necessarily equate directly to an effective drainage volume due to a variety of factors including possibly inadequate proppant distribution, reservoir damage, and reservoir heterogeneity.

Injected tracers are useful for addressing which stages of the completion are contributing to hydraulic fluid flow but have a limited utility life as the tracer is either absorbed to strata or their concentration depletes over time.

Pressure monitoring before and during production can be very helpful for determination of connectivity between wells because pressure responses between wells are a measurement of compression wave responses through a porous medium through time. Therefore, pressure monitoring adds a time component to understanding fracture connectivity, but still remains a remote detection method that cannot provide critical information about drained volumes.

Mechanical flow meters or remote sensing derived flow rate or volume are sometimes used to determine which parts of a well are contributing to production; however, neither method actually provides information on how far vertical or lateral from the well bore the fluid flow drainage is being derived. Ultimately, these technologies offer a wealth of information about the SRV and subsurface rock responses to completion and production but do not directly address effective drainage volume (DRV) per well.

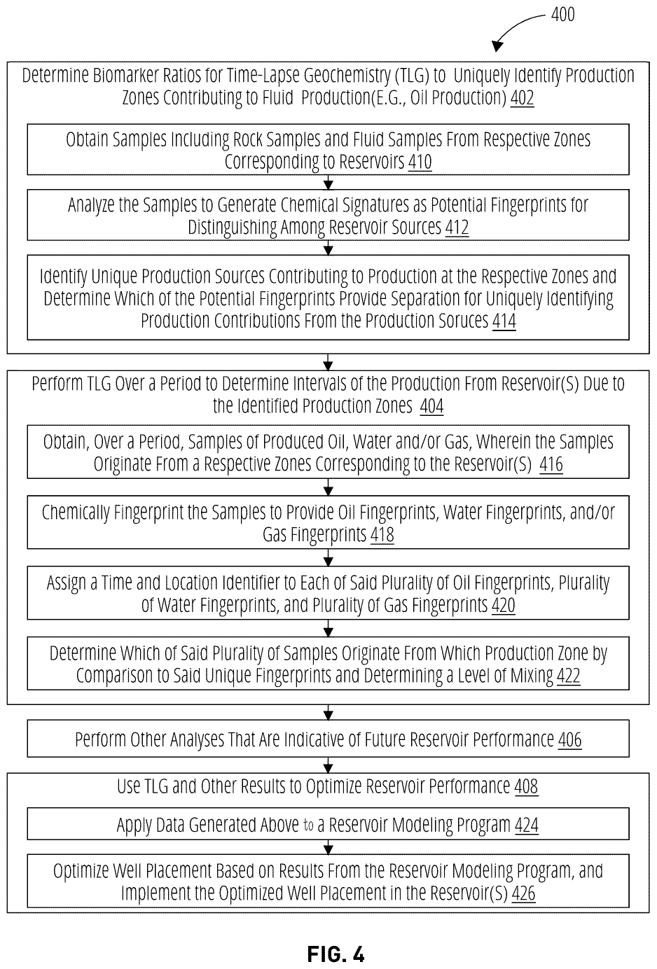

FIG. 4 illustrates an example method 400 for using TLG to allocate production. Although the example method 400 depicts a particular sequence of operations, the sequence may be altered without departing from the scope of the present disclosure. For example, some of the operations depicted may be performed in parallel or in a different sequence that does not materially affect the function of method 400. In other examples, different components of an example device or system that implements method 400 may perform functions at substantially the same time or in a specific sequence.

According to some examples, the method includes determining biomarker ratios for time-lapse geochemistry (TLG) to uniquely identify production zones contributing to fluid production (e.g., oil production) at process 402.

According to some examples, the method includes performing TLG over a period to determine intervals of the production from reservoir(s) due to the identified production zones 404.

According to some examples, the method includes performing other analyses that are indicative of future reservoir performance at block 406.

According to some examples, the method includes at use TLG and other results to optimize reservoir performance 408.

According to some examples, the method includes obtaining samples including rock samples and fluid samples from respective zones corresponding to reservoirs at block 410.

According to some examples, the method includes analyzing the samples to generate chemical signatures as potential fingerprints for distinguishing among reservoir sources at block 412.

According to some examples, the method includes identifying unique production sources contributing to production at the respective zones and determining which of the potential fingerprints provide separation for uniquely identifying production contributions from the production sources at block 414.

According to some examples, the method includes obtaining, over a period, samples of produced oil, water and/or gas, wherein the samples originate from respective zones corresponding to the reservoir(s) at block 416.

According to some examples, the method includes chemically fingerprinting the samples to provide oil fingerprints, water fingerprints, and/or gas fingerprints at block 418.

According to some examples, the method includes assigning a time and location identifier to each of said plurality of oil fingerprints, a plurality of water fingerprints, and a plurality of gas fingerprints at block 420.

According to some examples, the method includes determining which of said plurality of samples originate from which production zone by comparison to said unique fingerprints and determining a level of mixing at block 422.

According to some examples, the method includes applying data generated above to a reservoir modeling program at block 424.

According to some examples, the method includes optimizing well placement based on results from the reservoir modeling program and implementing the optimized well placement in the reservoir(s) at block 426.

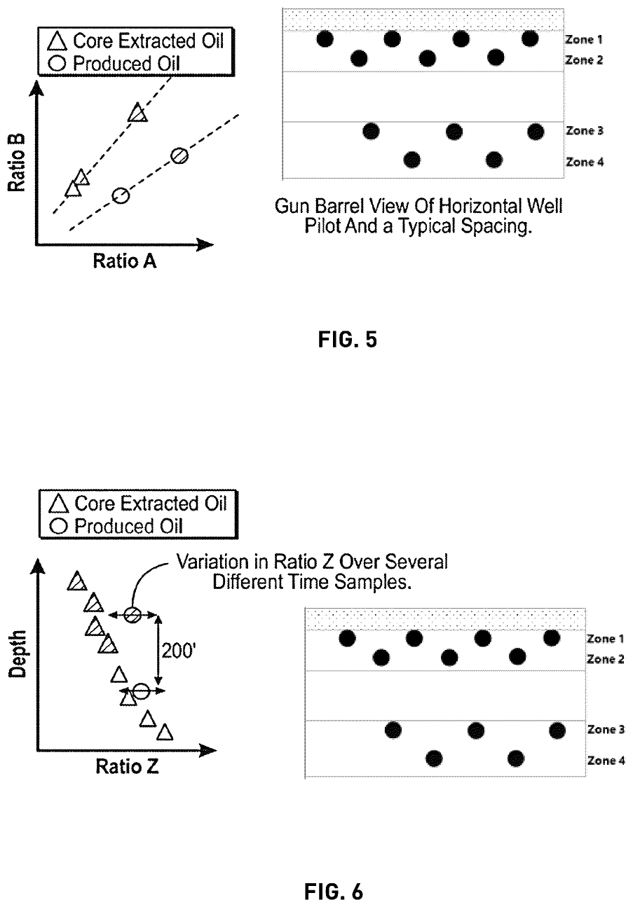

FIG. 5 illustrates an example of compound ratios that provide stratigraphic information (separate zone A and B) but are different between extracted oil and produced oil. Ratio A and B could be derived from gas chromatography or gas chromatography-mass spectrometry.

More particularly, FIG. 5 illustrates a cross-plot of two diagnostic biomarker ratios that separate time series production for Well A and B and the two MB and TF parent wells. The MB parent well can be observed to separate from MB infill well (Well A) production while the TF parent well does not separate from its infill well (Well B). The data also indicate how older parent well drainage can be affected upon infill drilling.

The systems and methods disclosed herein address two significant challenges with production allocation in unconventional tight reservoirs that are solved in this patent. The first challenge is that identifying end member signals can be difficult due to the fractionation between the in-situ reservoir fluid and the produced fluid. The second challenge is that the chemical signal of end-members is not a discrete function, but a continuous function (e.g. a gradient in the case of shale plays).

To address the first challenge, certain implementations of the systems and methods disclosed herein use end-member chemical signals that are determined from extracted oils using interior core parts. These extracted oil chemical signals do not necessarily correlate with produced oil due to the fractionation of compounds during production. Compound fractionation is not restricted to low permeability reservoirs but has even been observed for higher permeability conventional reservoirs.

Prior attempts to minimize or circumvent the fractionation differences between in-situ and produced fluid in the E&P industry have been tried with the use of extensive preservation (e.g. dry ice and sealing samples at rig site) and/or variable sequential extraction methods in the lab. These methods, while helpful, have shortfalls including: a) control of the rig site samples is not always easy or possible, b) sequential extraction methods are likely to be different or change for different rock types and mineralogy, and c) it is time consuming and expensive to derive the correct extraction method.

The systems and methods disclosed herein address the first challenge by using some of the many (e.g., hundreds or thousands) chemical compounds that do not fractionate during production, resulting in these chemical compounds remaining largely unchanged when brought to the surface. An example could be isomers of the same compound (e.g. 1 versus 9 methylphenanthrene), which should behave very similarly between in-situ and produced oil. The challenge is finding those compounds that are not fractionated between in-situ and produced oils. At the same time, these compounds and compound ratios must carry information in the vertical stratigraphic (age) domain. It is very common to find compounds that carry stratigraphic information but do not pass the screen test for fractionation, as illustrated in FIG. 5. These compounds can still be useful in a qualitative sense for pilot monitoring but do not allow for quantitative production allocation, which are used to derive information on vertical drainage height.

To derive compounds and subsequent ratios that are similar between extracted oil and produced oil, a cloud-based application is used to handle large data sets of extracted oils, produced oils, and compounds. The macro automatically builds non-normalized (AB) and normalized (A/A+B) ratios of all possible ratios from the compound data supplied. The ratios are ranked according to Pearson product correlation coefficients against an alphanumeric target variable. In practice, since the acceptable correlation could be either strongly positive or negative, the ranking is conducted by using a square of Pearson correlation, in place of Pearson correlation, which is given by

$${ρ}_{BR , α} = \frac{{\sum }_{j = 1}^{m} ( {r}_{i , j} - \frac{1}{m} {\sum }_{j = 1}^{m} {r}_{i , k} ) ( {α}_{j} - \frac{1}{m} {\sum }_{j = 1}^{m} {α}_{k} )}{\sqrt{{\sum }_{j = 1}^{m} {( {r}_{i , j} - \frac{1}{m} {\sum }_{j = 1}^{m} {r}_{i , k} )}^{2}} \sqrt{{\sum }_{j = 1}^{m} {( {α}_{j} - \frac{1}{m} {\sum }_{j = 1}^{m} {α}_{k} )}^{2}}}$$

FIG. 6 illustrates an example of ratios found that are common for extracted and produced oils and carry stratigraphic information. The dynamic range of the ratio in the produced oil falls within the range of that from the extracted oil end members.

In production allocation for unconventional reservoirs, the target variable typically confers vertical or stratigraphic distance and is either the actual core measured depth, true vertical depth, or may be grouped by zone. In addition, in order to find ratios that are consistent between the extracted oil and produced oil, this process is performed on a combined extracted oil (from core samples) and produced oil data set. The produced oil is coded in the alpha numeric array closest to the zone of well landing that corresponds to the equivalent depth in the rock extracted oil, as illustrated in FIG. 6.

Horizontal well production will be a vertical mixture of produced fluid composite over the whole well length. However, for tight reservoirs it is reasonable to assume that most of the oil produced is proximal to the target landing zone. Having produced oil from multiple zones helps to seed the search for common ratios. The result is that out of thousands of possible chemical ratios there will start to sort out some ratios that provide both vertical stratigraphic information and are in the same dynamic range for produced and extracted oils, as illustrated in FIG. 6.

The ratios found in this manner are still not completely ready for the next step of production allocation. The ratios must be screened to ensure that the dynamic range of the production is never outside that of the potential end-member solution extracted oils.

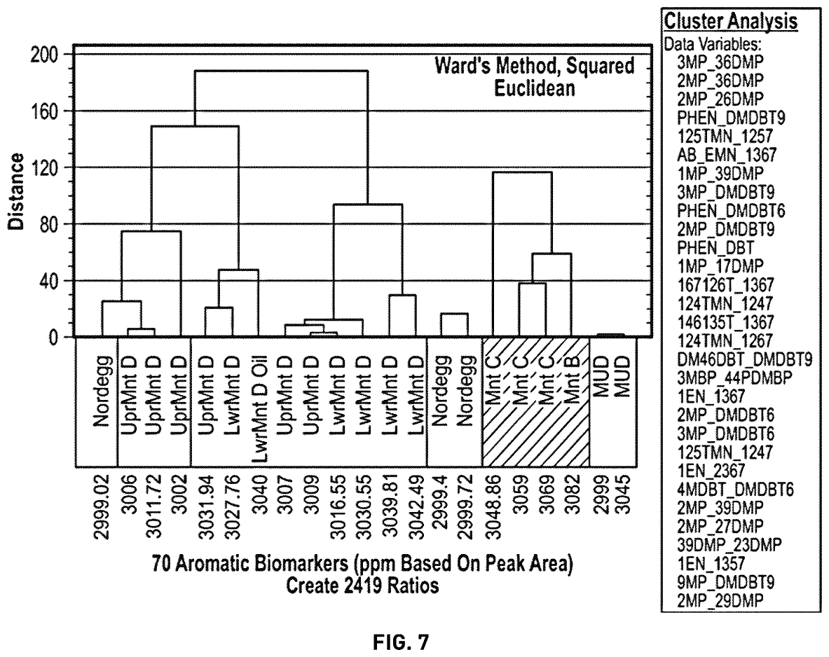

FIG. 7 illustrates an example of using hierarchical cluster analysis (HCA) on a set of common ratios for produced oil and extracted oil with stratigraphic information. The groupings show qualitatively the main contributors to the oil sample from a horizontal lateral. The HCA also shows that the common ratios used are clearly separate from the drilling mud as a potential contaminant.

Here, a screening process is shown for the relative concentration of the compounds that constitute the ratios. The mathematical solutions used for production allocation will assume linear mixing rules, which will not be valid if concentration differences are significant among the end members. Ideally, the concentration differences will be zero, but in practice, small differences in concentration can be tolerated with some acceptance of error in solution. For example, concentration differences of up to a factor of 2 difference between end members will still result in <5% error in the allocation solution. In practice, large compound concentration differences over the section of allocation are not typically a problem in liquid rich shale plays but may become significant in hybrid plays. For most projects, ratios are used that have concentration differences less than a factor of 2.5 between compounds.

If there is any indication that the samples used for end-member derivation could be contaminated by drilling fluids, then the process above is repeated running the numerical array with the macro where drilling mud compounds are included but not coded in the array. The ratios are then checked for correlation with the drilling mud, most commonly by using hierarchical cluster analysis, as illustrated in FIG. 7. If the top-ranking common ratios for produced oil and extracted oil do not easily separate from the drilling mud, then the ratio data needs to be sorted for non-mud validity. This sorting can be done by re-coding the target variable between the drilling mud and the already high-graded common ratio set that contains stratigraphic information.

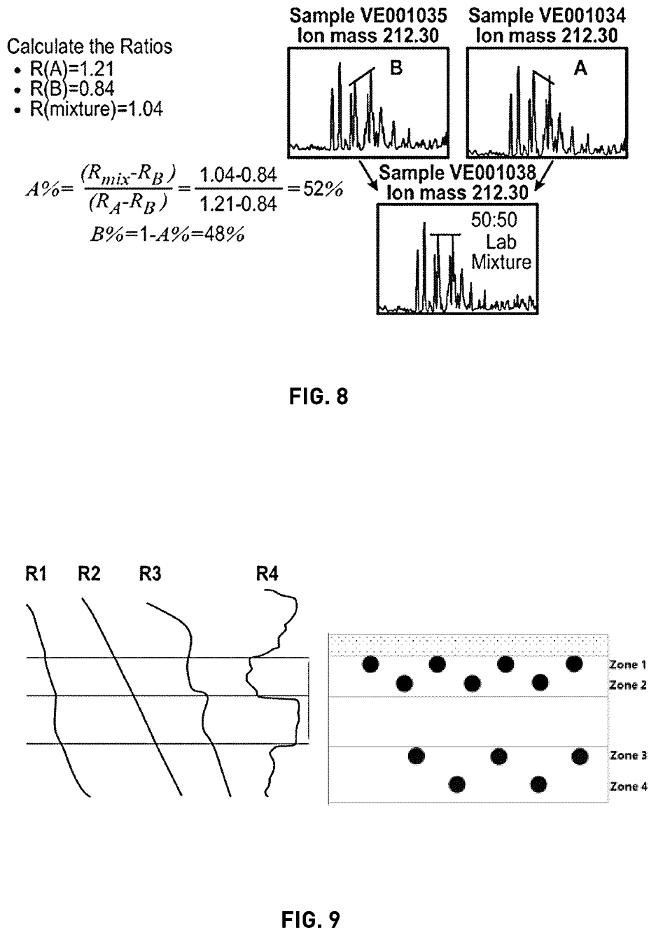

FIG. 8 illustrates an example of a discrete end-member matrix with two end-members. The concentrations of the compounds in this example are similar and mix in a linear manner as proven by the physical lab mixture.

The main workflow for ratio generation, selection, and screening is summarized in Table 1. Another screening that may be applied involves analytical error of measurement from the GC or GC-MS data for the selected ratios. This is commonly addressed by measuring external standards and determining the error bar for selected ratios and using a constant instrument for the life of the allocation project.

TABLE 1
Summary of ratio selection and screening prior to
performing quantitative production allocation.

| | Contamination | | Concentration |
|---|---|---|---|
| Pearson product | with drilling | | difference |
| correlation | fluids or other | Dynamic range | check |
| Select highest | Ratios can see | Produced oil | Up to 4 to 1 |
| relationship by | around the mud or | ratios are in | is about |
| stratigraphy, | other contaminates | the same | an 8% error |
| common to | | range as core | |
| extracted and | | extract oil | |
| produced oil | | | |

In view of the above a challenge arise when finding a discrete end-member solution because the production allocation solution can be unique given more or equal ratios than end-members, and illustrated in FIG. 8.

FIG. 9 illustrates an example of multiple ratios (e.g., R1, R2, R3, and R4) that have different resolution or separating capacity with depth.

In the case of unconventional tight reservoir production allocation, the end-members often form a continuous gradient (positive or negative) with depth in the case of liquid rich shale plays to multiple gradients in the case of hybrid plays. In either case, some ratios may provide a high degree of separation information over only a selected depth range, but provide no information over other depth ranges. The solution is to incorporate multiple ratios over the allocation depth range and solve simultaneously to an objective function such as minimum least-square Σ(x1−x0)2.

The matrix linear algebra solution used is shown schematically below.

Matrix Solution: Linear
Algebra R*W = P

| | End | | | | Produced | | |
|---|---|---|---|---|---|---|---|
| | Member | | | | Oil | | |
| | Biomarker | | Production | | Biomarker | | |
| | Ratio | | Allocation | | Ratio | | |
| | (R) | × | (W) | = | (P) | | |
| | EM₁ | EM₂ | . . . | EMₘ | | w₁ | p₁ |
| BR1 | r_{1,1} | r_{1,2} | . . . | r_{1,m} | | w₂ | p₂ |
| BR2 | r_{2,1} | r_{2,2} | . . . | r_{2,m} | | . . . | p₃ |
| BR3 | r_{3,1} | r_{3,2} | . . . | r_{3,m} | | wₘ | . . . |
| . . . | . . . | . . . | . . . | . . . | | | pₙ |
| BRn | r_{n,1} | r_{n,2} | . . . | r_{n,m} | | | |

```
${p}_{i} = {\sum }_{j = 1}^{m} {r}_{i , j} {ω}_{j} , where$
    i = 1, 2, . . . n and
      n ≥ m, and
    ${\sum }_{j = 1}^{m} {ω}_{j} = 1 , where$
      0 ≤ ωⱼ ≤ 1,
    System: R × W = P
Constraint: wⱼ ≥ 0 for j ∈
      {1, . . . , m}
Algorithm:
    1. [symbol]  Initialize [symbol]
${ω}_{j} = \frac{1}{m} for j ∈ \{ 1 , … , m - 1 \} , or \text{?} by$ [symbol]
      random [symbol]
      sampling
    2. Set up cloud-based
      solver to minimize
    mismatch function by
        controlling wⱼ for
    j ∈ {1, . . . , − 1} with
          the constraint
    3. [symbol]  Calculate [symbol]
      ${ω}_{m} = 1 - {\sum }_{j = 1}^{m - 1} {ω}_{j} ,$ [symbol]
            directly [symbol]
      embedding
    ${\sum }_{j = 1}^{m} {ω}_{j} = 1 into \text{?} the$ [symbol]
          workflow
      4. Predict produced
    biomarker ratio based on
    the system equation, P =
                  R × W
      5. [symbol]  Calculate [symbol]
    mismatch [symbol]  function,
                  e.g.
    ${\sum }_{i = 1}^{n} {( {p}_{i}^{produced} - {p}_{i}^{predicted} )}^{2}$
              6. Check for
            convergence
    a. If convergence fails,
    based on the mismatch
      function and previous
                  iterations,
          cloud-based solver
      suggests a new set of wⱼ
    for j ∈ {1, . . . , m - 1};
                    then,
          repeat Steps 2 - 6
        b. If convergence is
            achieved, stop
            ${p}_{i} = {\sum }_{j = 1}^{m} {r}_{i , j} {ω}_{j} , where i = 1 , 2 , … n and n \geq m , and$
            ${\sum }_{j = 1}^{m} {ω}_{j} = 1 , where 0 \leq {ω}_{j} \leq 1 ,$
```

wherein wⱼ is a production allocation of a j^{th} production zone, r_{i,j} is a biomarker ratio value corresponding to the j^{th} production zone and an i^{th} biomarker ratio, and pᵢ is an aggregated value of the i^{th} biomarker ratio, wherein values of the production allocations wⱼ are optimized subject to

$${\sum }_{j = 1}^{m} {w}_{j} = 1$$

to generate aggregated values of the biomarker ratios pᵢ that most closely match measured values of the at least one compound ratio or isotope ratio for the produced samples.

Depending on the characteristics of the data, different mismatch functions yield different algorithmic behavior and consequently different solutions. In this development, several mismatch functions are included to handle a wide range of problems.

### Available Mismatch Functions:

Least square,

$${\sum }_{i = 1}^{n} {( {p}_{i}^{produced} - {p}_{i}^{predicted} )}^{2}$$

Least square with normalization,

$$\frac{{Σ}_{i = 1}^{n} {( {p}_{i}^{produced} - {p}_{i}^{predicted} )}^{2}}{{{Σ}_{i = 1}^{n} ( {p}_{i}^{produced} )}^{2}}$$

Least square with range correction,

$${{Σ}_{i = 1}^{n} ( \frac{{p}_{i}^{produced} - {p}_{i}^{predicted}}{{p}_{i}^{produced}} )}^{2}$$

Cauchy, Σᵢ₌₁ⁿ(1+0.5 (pᵢ^{produced}−pᵢ^{predicted})²)
Cauchy with range correction,

$${Σ}_{i = 1}^{n} ( 1 + 0.5 {( \frac{{p}_{i}^{produced} - {p}_{i}^{predicted}}{{p}_{i}^{produced}} )}^{2} )$$

Range corrected absolute difference,

$${Σ}_{i = 1}^{n} \frac{\vert {p}_{i}^{produced} - {p}_{i}^{predicted} \vert}{\vert {p}_{i}^{produced} \vert}$$

Sensitivity Analyses. As stated in “Problem #2 solution”, a larger number of biomarker ratios than the number of end-members are necessary to accommodate the continuous gradient nature of the ratios in an unconventional tight reservoir. To efficiently determine an appropriate number of biomarker ratios, in this development, the sensitivity test can be facilitated in both automatic and manual fashions.

In addition, the choice of end-members can have impacts on the calculated production allocation as well. For the experts to investigate this sensitivity, the development can generate all possible permutations among all end-members for the calculation, with optional controls—the range of numbers of end-members, filtering for only combinations with certain landing zones, and whether skipping end-members is allowed. Landing zone in this context refers to the horizon in which the horizontal lateral was landed. Landing zone specification and end-member forcing are methods to introduced geologic control and influence on the solutions.

Exploring Alternative Solutions. In the sensitivity analyses, one may arrive at multiple solutions based on different selections of biomarker ratios and end-members. However, those solutions do not represent the uncertainty, associated with the measured quantities-both core extract data and produced samples.

To quantify the uncertainty in the calculated production allocation, after the determination of appropriate sets of biomarker ratios and end-members, multiple realizations of core extract data and produced samples can be generated based on their associated measurement errors. This uncertainty quantification is classified as a Monte Carlo Simulation method.

An extra iteration loop is applied to the presented algorithm to generate realizations of production allocation. In each iteration, the end-member biomarker ratios (r_{i,j}) and the produced biomarker ratios (pᵢ) are replaced by realization k of the quantiues

$$( {r}_{i , j}^{k} and {\underline{p}}_{i}^{k} )$$

that are randomly uniformly sampled from

$${r}_{i , j}^{k} ∈ [ {r}_{i , j} ( 1 - {ε}_{end - member} ) , {r}_{i , j} ( 1 + {ε}_{end - member} ) ] . and$$

$$i {p}_{i}^{k} ∈ [ {p}_{i} ( 1 - {ε}_{produced} ) , {p}_{i} ( 1 + {ε}_{produced} ) ] ,$$

respectively. Then, the associated uncertainty of the production allocation can be represented by the ensemble of solutions with a large enough number of realizations.

During each iteration, the mismatch function is based on the difference between

$${p}_{i}^{k , produced} and {p}_{i}^{k , predicted} .$$

However, the presented outcomes in this development are based on

$${p}_{i}^{produced} and {p}_{i}^{k , predicted} .$$

This is so that the realizations can be compared among one another as the presented mismatch values have the same reference,

$${p}_{i}^{produced} .$$

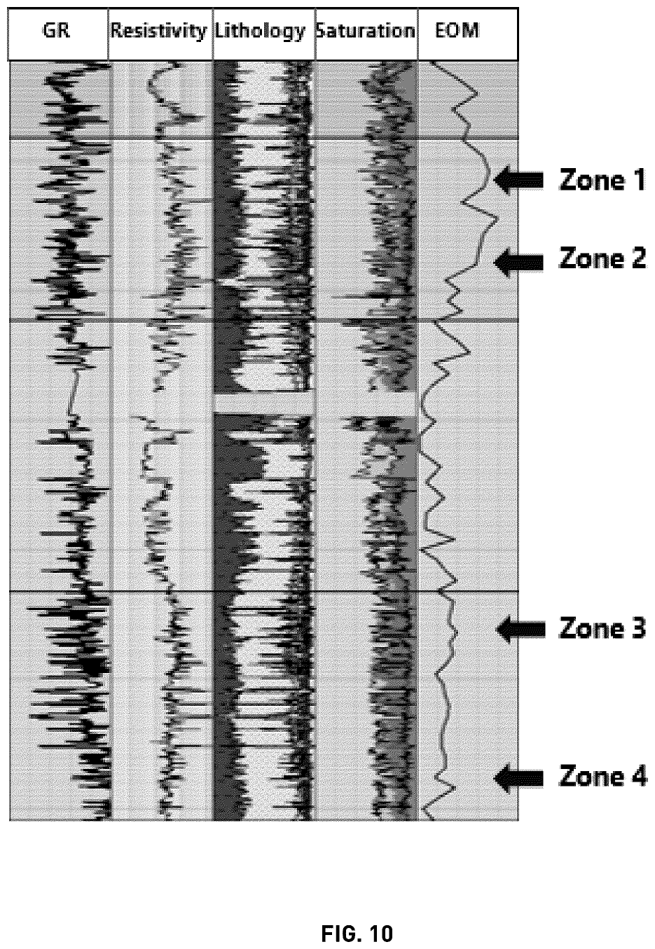

FIG. 10 illustrates a non-limiting example a well log from the pilot-hole well (i.e., Well C) together with associated core gamma ray (GR) and bulk volume oil (BVO). Further FIG. 10 includes annotations showing the location of the two horizontal TLG wells (i.e., Well A and Well B).

Additionally, FIG. 10 illustrates a non-limiting example of applying method 400 to the Williston Basin, which is an intracrationic basin with its center in North Dakota. In this non-limiting example, there are two major formations of hydrocarbon production in the Williston Basin—the Late Devonian-Early Mississippian age Bakken Formation, and the underlying Devonian Three Forks Formation. The 2013 USGS assessed an undiscovered, technically recoverable resource estimate of the Bakken Formation at 3.65 billion bbl and the Three Forks at 3.73 billion bbl. The area discussed for this non-limiting example is located in the Mckenzie County, adjacent to the Nesson Anticline, which is considered the sweet spot of the basin.

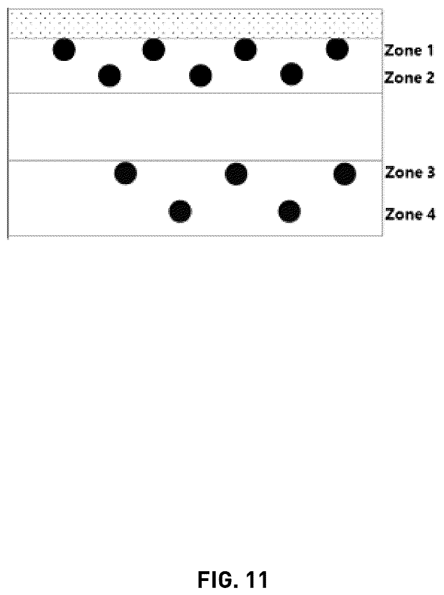

For this non-limiting example, end-member oil samples (samples of oil from each of the different production zones being commingled) were extracted from the interior pieces of a fresh preserved core from a pilot-hole well (Well C). A number of oil extracts were selected from the stratigraphic zones of interest. A full year of produced oil, gas and water sampling starting from flow-back was launched on two wells (as illustrates in FIG. 10 and FIG. 11) that were in close proximity to where the core was taken. Samples were taken at 12-hour interval during flowback and spaced out at 2-month intervals at the end.

Four producing end-members can be identified from core extracts and used in this non-limiting example (i.e., the Upper and Lower Bakken Shale (UBS/LBS), Middle Bakken (MB), Upper Three Forks (UTF), and the Middle Three Forks (MTF)). The Upper and Lower Bakken Shales were indistinguishable in terms of their chemical composition, and they are therefore lumped into one end-member. Other surrounding intervals were considered only marginally productive and were ignored in this example.

Whole oil gas-chromatography (GC), API gravity, and gas-chromatography mass-spectrometry (GC-MS) on the saturates and aromatics were conducted on the core extracts and produced oils.

For this non-limiting example, it was observed that the GC-MS on the aromatic fractions carried the most effective information on the vertical zone differentiation, and these were therefore used for the quantitative production allocation reported herein.

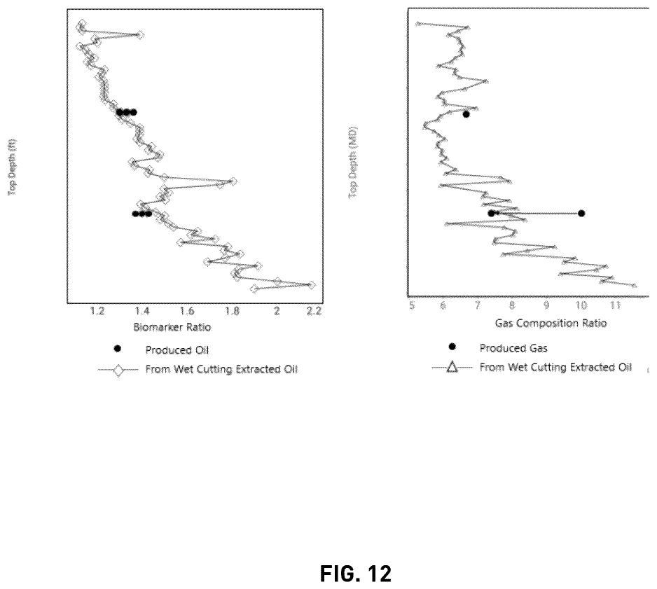

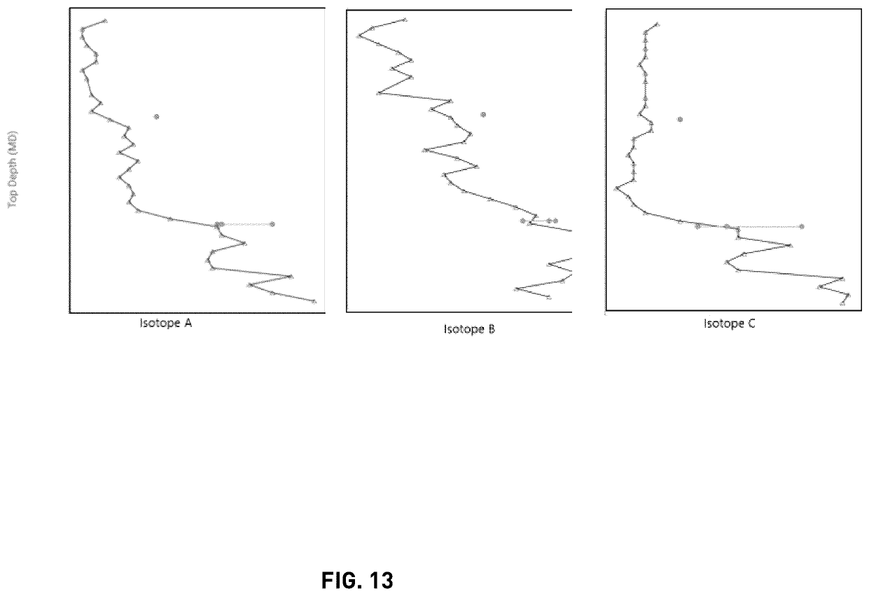

FIG. 12 illustrates a cross-plot of chemical signatures vs. depth in end-members for produced oil; a cross-plot of chemical signatures vs. depth in end-members for produced gas; and a cross-plot of chemical signatures vs. depth in end-members for produced water. These cross-plots illustrate that, in the ono-limiting example of the Williston Basin, oil and water geochemistry were found to be most useful for performing quantitative production allocation by interval. By contrast, the ability to establish end-members for gas composition with only drilling mudgas composition for comparison was insufficient for quantitative calculation, although trends clearly existed that were qualitatively consistent with both the oil and water chemistry.

FIG. 13 illustrates a cross-plot of chemical signatures vs. depth in end-member water compared to produced water. Similar to FIG. 12, the water chemistry illustrated in FIG. 13 can be used to qualitatively assist with the allocation, but a quantitative allocation using only water chemistry may be challenging due to a limited number of available isotopes.

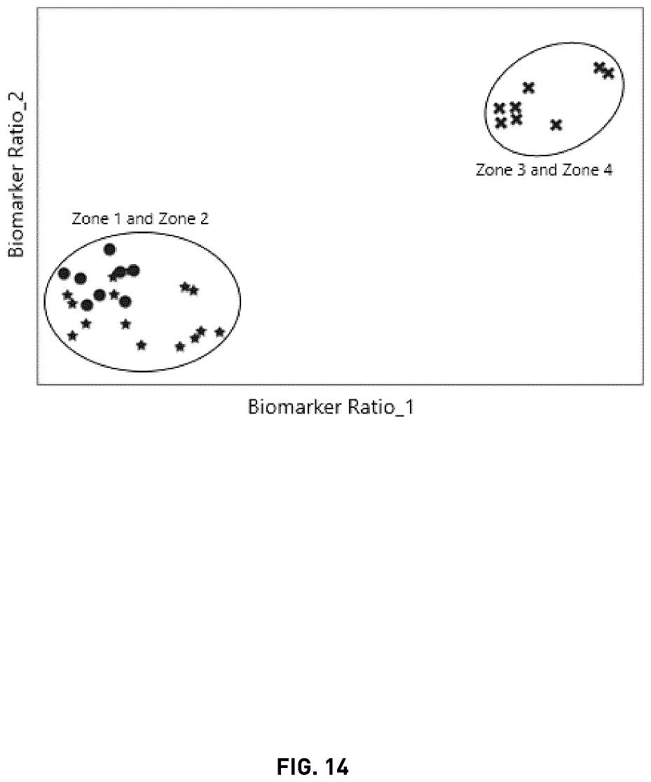

FIG. 14 illustrates that the ratios between the selected biomarkers was able to provide good separation between the MB and the TF intervals in oil samples produced from two pilots (i.e., Pilot 1 and Pilot 2). More particularly, FIG. 14 shows the separation between MB and TF intervals using two biomarker ratios in produced oil samples from Pilot 1 and 2 areas, which are about 6 miles apart.

FIG. 14 shows a strong cross contribution was shown between the MB and TF wells, which appeared to continue over the length of one year. Initially, Well A produced about 55% from the MB interval while the UTF contributed about 40%. Well B produced about 62% from the UT interval and produced about 32% from the MB interval. The contribution from shale was less than about 5% for both wells during the year that is shown.

Despite large volumes of in-place oil in the UBS and LBS, their contribution was found to be minimal and close to the error bar of ^{~}±5% on the methodology. The shale contribution did appear to be slightly higher at initial flow back time relative to long term production, as discussed below with respect to FIG. 15 and Table 2. The low amount of shale contribution is consistent with the order of magnitude higher permeability in MB and TF reservoir intervals compared to the shales.

FIG. 15 illustrates the derived contributions of the respective end-member to the total production for two wells (i.e., Well A and Well B) over a period of 12 months. More particularly, FIG. 15 illustrates the 12-month production allocation results of the produced oil from Well A (MB well) and B (TF well).

The UBS and LBS end-members had large volumes of in-place oil, but their contributions to the 12-month production allocation at Well A and Well B was found to be minimal (e.g., close to the error bar of ~+5% when applying the methodology in this non-limiting study). The shale contribution did appear to be slightly higher at initial flow back time relative to long term production. The low amount of shale contribution is consistent with the order of magnitude higher permeability in MB and TF reservoir intervals compared to the shales.

The TLG data support a preferential fracture growth upward in UTF wells and downward in MB for the completion design applied in the pilot. The TLG supported the idea that fractures through the LBS are remaining propped open to flow for both MB and UTF producers up to 1 yr.

TABLE 2
Quantitative allocation results of the produced oil from
Well A (MB well) and B (TF well) in 12-month period.

| | Flow- | 0-6 M | 7-12 | Full Year |
|---|---|---|---|---|
| | back | Avg. | Avg. | Avg. |
| 12 Month Oil Production | | | | |
| Allocation of Well A | | | | |
| UBS/LBS | 9% | 6% | 4% | 5% |
| MB | 56% | 54% | 55% | 55% |
| UTF | 35% | 40% | 40% | 40% |
| MTF | | | 1% | |
| 12 Month Oil Production | | | | |
| Allocation of Well B | | | | |
| UBS/LBS | 7% | 4% | 3% | 3% |
| MB | 40% | 34% | 29% | 32% |
| UTF | 53% | 59% | 66% | 62% |
| MTF | | 4% | 2% | 3% |

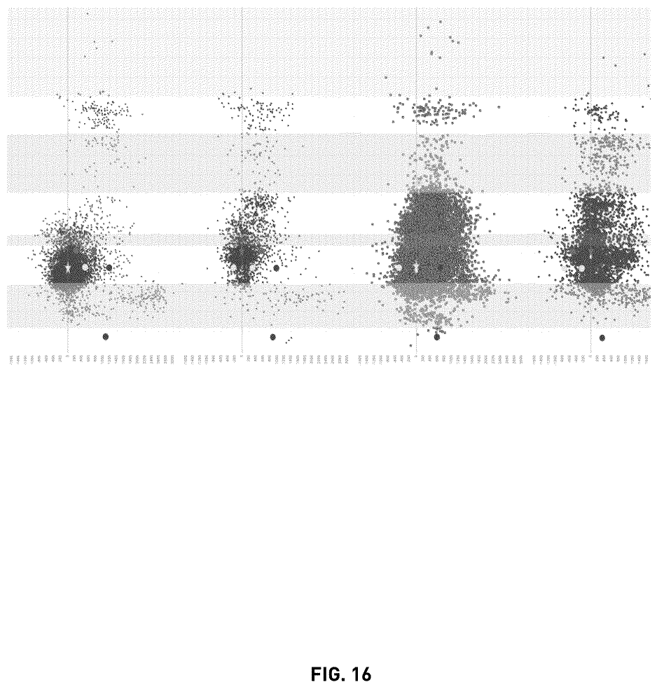

FIG. 16 illustrates plots of micro-seismic events observed in Well A (production mostly from MB) and B (production mostly from UTF). The plots show the location of vertical monitor well. In this non-limiting example, the area under study provided a data-rich, multi-well pilot where micro-seismic data was also collected. The data-rich, multi-well pilot also included collecting chemical-tracer tests and interference tests. In this area the DRV interpreted from the TLG results is more constrained than the SRV, as provided by the micro-seismic data. For Well A, the fracture height reflected by the micro-seismic data indicated the fractures reached up well beyond the UBS and down into the Middle and Lower TF, while TLG data indicated DRV was largely constrained between UBS and UTF. For Well B, micro-seismic results showed fracture growth upwards into the Lodgepole layers and downward to the lower portion of the LTF, while the TLG-provided DRV shows limited downward growth to MTF, which is consistent with production allocation indications of limited MTF contribution to production.

The use of the systems and methods disclosed herein provides improvements over the SRV concept, as illustrated by the above-noted differences. For example, the misapplication of the SRV concept largely explains the differences observed in the current study. SRV calculation is based on the spatial distribution of events, proximity to neighboring events, and event density. The relationship between SRV and fracture geometry is not completely understood, and micro-seismic events do not reveal information for fracture conductivity and connectivity to the wellbore. The SRV is indicative of the fracture height, length, and location, but the amount of the stimulated rock actually contributing to oil/gas/water production also hinges on many other factors including matrix permeability, proppant location, etc.

In comparison, the results based on the TLG methodology disclosed herein are based on the produced fluid itself, and the DRV calculated from the TLG data directly represents where the hydrocarbon and water is drained from as a result of combined effects of SRV, fracture and reservoir conductivity, proppant placement, etc. Therefore, it is understandable that the SRV is often estimated to be larger than the DRV as observed in the non-limiting example discussed herein.

It is inherent that any diagnostic tool can only provide insights on what has happened but cannot predict what will happen. Therefore, to predict the impact of key completion and development variables (landing zone, well spacing, job size, slick water vs. gel completion, etc.) to planning the field development, all information needs to be captured in a reservoir model. The TLG results are thus integrated with rock fracture modeling, rock and fluid properties and production information to calibrate the reservoir model and eventually explore the economic impact of assorted well spacing and stacking arrangements.

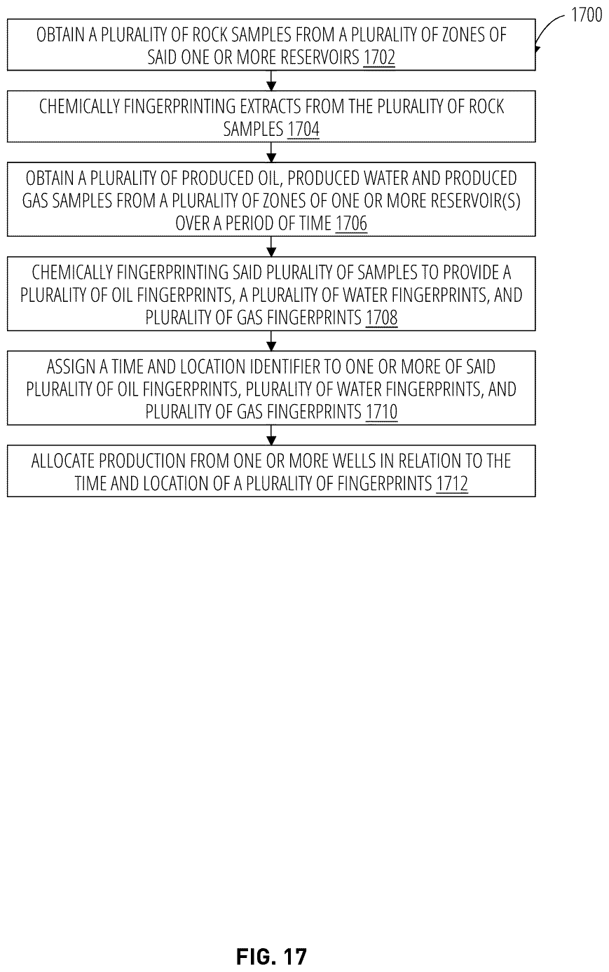

FIG. 17 illustrates an example method 1700 for using TLG to allocate production. Although the example method 1700 depicts a particular sequence of operations, the sequence may be altered without departing from the scope of the present disclosure. For example, some of the operations depicted may be performed in parallel or in a different sequence that does not materially affect the function of the method 1700. In other examples, different components of an example device or system that implements the method 1700 may perform functions at substantially the same time or in a specific sequence.

According to some examples, the method includes obtaining a plurality of rock samples from a plurality of zones of said one or more reservoirs at block 1702.

According to some examples, the method includes chemically fingerprinting extracts from the plurality of rock samples at block 1704.

According to some examples, the method includes obtaining a plurality of produced oil, produced water and produced gas samples from a plurality of zones of one or more reservoir(s) over a period of time at block 1706.

According to some examples, the method includes chemically fingerprinting said plurality of samples to provide a plurality of oil fingerprints, a plurality of water fingerprints, and plurality of gas fingerprints at block 1708.

According to some examples, the method includes assigning a time and location identifier to one or more of said plurality of oil fingerprints, plurality of water fingerprints, and plurality of gas fingerprints at block 1710.

According to some examples, the method includes allocating production from one or more wells in relation to the time and location of a plurality of fingerprints at block 1712.

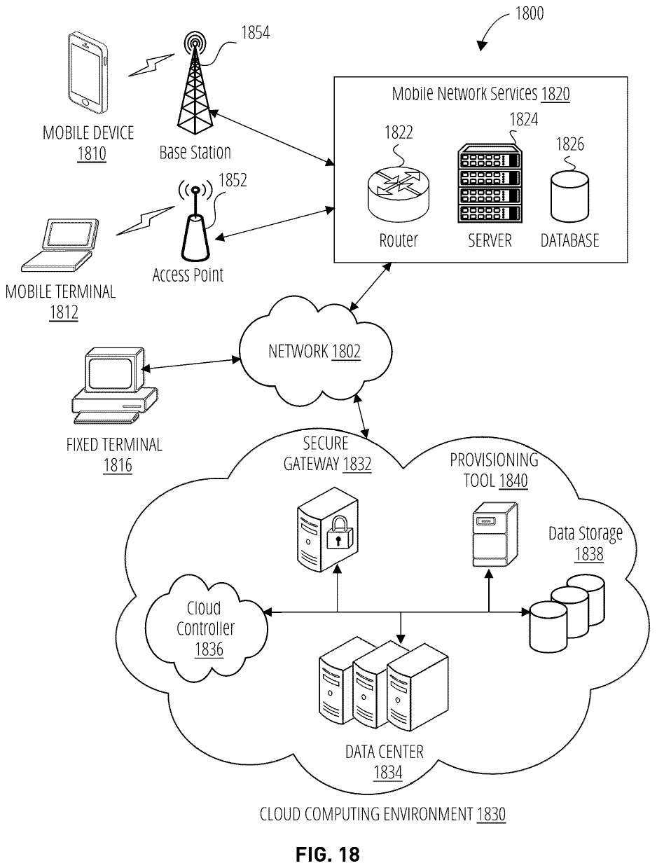

The functions and features described herein may also be executed by various distributed components of a system. For example, one or more processors may execute these system functions, wherein the processors are distributed across multiple components communicating in a network. The distributed components may include one or more client and server machines, which may share processing, as shown on FIG. 18, in addition to various human interface and communication devices (e.g., display monitors, smart phones, tablets, personal digital assistants (PDAs)). The network may be a private network, such as a LAN or WAN, or may be a public network, such as the Internet. Input to the system may be received via direct user input and received remotely either in real-time or as a batch process. Additionally, some implementations may be performed on modules or hardware not identical to those described. Accordingly, other implementations are within the scope that may be claimed.

In some implementations, the described herein may interface with a cloud computing environment 1830 to perform at least portions of methods or algorithms detailed above. The processes associated with the methods described herein can be executed on a computation processor, such as data center 1834. The data center 1834, for example, can also include an application processor that can be used as the interface with the systems described herein to receive data and output corresponding information. The cloud computing environment 1830 may also include one or more databases 1838 or other data storage, such as cloud storage and a query database. In some implementations, the cloud storage database 1838, may store processed and unprocessed data supplied by systems described herein. As discussed above, the cloud computing environment 1830 may support scalable processing of layered or tower pricing structures of multiple participants of a transactional platform. The pre-processing of some data (e.g., peer data for analysis), for example, may enable real-time responses to users evaluating layered or tower pricing structures.

The systems described herein may communicate with the cloud computing environment 1830 through a secure gateway 1832. In some implementations, the secure gateway 1832 includes a database querying interface.

The cloud computing environment 102 may include a provisioning tool 1840 for resource management. The provisioning tool 1840 may be connected to the computing devices of a data center 1834 to facilitate the provision of computing resources of the data center 1834. The provisioning tool 1840 may receive a request for a computing resource via the secure gateway 1832 or a cloud controller 1836. The provisioning tool 1840 may facilitate a connection to a particular computing device of the data center 1834.

A network 1802 represents one or more networks, such as the Internet, connecting the cloud environment 1830 to a number of client devices such as, in some examples, a cellular telephone 1810, a tablet computer 1812, a mobile computing device 514, and a desktop computing device 1816. Network 1802 can also communicate via wireless networks using a variety of mobile network services 1820 such as Wi-Fi, Bluetooth, cellular networks including EDGE, 3G and 4G wireless cellular systems, or any other wireless form of communication that is known. In some implementations, the network 1802 is agnostic to local interfaces and networks associated with the client devices to allow for integration of the local interfaces and networks configured to perform the processes described herein.

In the present disclosure, the methods disclosed may be implemented as sets of instructions or software readable by a device. Further, it is understood that the specific order or hierarchy of steps in the methods disclosed are instances of example approaches. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

1. A method of allocating production, comprising:
storing, at a cloud-computing platform, component data representing chemical attributes measured for samples from respective production zones of one or more reservoirs, wherein the component data includes oil data, water data, and gas data, and the component data includes respective parts corresponding to measurements of samples;
associating the respective parts the component data with times and locations at which the samples are collected;
selecting, at the cloud-computing platform and based on the component data, at least one compound ratio or isotope ratio that uniquely identifies from which of the respective production zones a produced fluid originates, thereby enabling an analysis of a mixture of produced fluids originating from the respective production zones that determines production allocations from the respective production zones;
storing, at the cloud-computing platform, time-series data representing chemical attributes measured at a series of times for productions from a well;
analyzing, at the cloud-computing platform, the time-series data using the at least one compound ratio or isotope ratio to determine production intervals by estimating respective contributions of the productions corresponding to the respective production zones.

2. The method of claim 1, further comprising:
sharing, via the cloud-computing platform and among a plurality of users, access to the component data, the time-series data, analysis tools used in selecting the at least one compound ratio or isotope ratio and/or analyzing the time-series data of the productions using the at least one compound ratio or isotope ratio.

3. The method of claim 1, further comprising:
using a cloud-based application to process the component data by analyzing a plurality of ratios including non-normalized (AB) ratios and normalized (A/A+B) ratios of all possible compound ratios ranking ratios according to a square of Pearson correlation, wherein
a ratio is selected as a candidate for the at least one compound ratio or isotope ratio if the ratio satisfies criteria of i) the ratio is generally constant between rock samples and the productions, ii) each compound in the ratio follows linear mixing rules, and iii) the ratio provide separation from drilling mud ratios.

4. The method of claim 3, further comprising:
using the cloud-based application to analyze the time-series data of the productions using at least one of the compound ratio or the isotope ratio to determine the production intervals.

5. The method of claim 1, wherein:
the component data includes chemical signatures measured from rock samples collected from the respective production zones,
the time-series data includes the chemical signatures measured from the productions and is analyzed using an artificial intelligence model, and
the at least one compound ratio or isotope ratio are ratios of compounds that are generally constant for both the rock samples and the productions.

6. The method of claim 5, wherein:
the productions include a hydrocarbon resource produced from the well,
the at least one compound ratio or isotope ratio is selected based on providing sufficient separation to distinguish a first produced fluid of a first production zone from a second fluid of a second production zone, and
the at least one compound ratio or isotope ratio are selected from hydrocarbon compound ratios, aromatic biomarker ratios, isotope ratios, gas compositional ratios, and water isotope ratios.

7. The method of claim 1, wherein analyzing the time-series data to determine the production intervals by estimating the respective contributions to the productions corresponding to the respective production zones includes calculating:
$${p}_{i} = {\sum }_{j = 1}^{m} {r}_{i , j} {w}_{j} , where i = 1 , 2 , … n and n \geq m , and$$
$${\sum }_{j = 1}^{m} {w}_{j} = 1 , where 0 \leq {w}_{j} \leq 1 ,$$
wherein wⱼ is a production allocation of a j^{th} production zone, r_{i,j} is a ratio value for the at least one compound ratio or isotope ratio, r_{i,j} corresponding to the j^{th} production zone and an i^{th} ratio value, and pᵢ is an aggregated value of the i^{th} ratio value, wherein values of the production allocations wⱼ are optimized subject to
$${\sum }_{j = 1}^{m} {w}_{j} = 1$$
to generate the aggregated values pᵢ that most closely match measured values of the at least one compound ratio or isotope ratio for the productions.

8. The method of claim 7, wherein optimizing the values of the production allocations wⱼ to generate the aggregated values pᵢ that most closely match measured values of the at least one compound ratio or isotope ratio for the productions includes minimizing a mismatch function between produced values of biomarker ratios and predicted values of the biomarker ratios, and the mismatch function is selected from the group consisting of a least squares mismatch function, a least square with range correction mismatch function, a Cauchy mismatch function, a Cauchy with range correction mismatch function, and a range corrected absolute difference mismatch function.

9. The method of claim 1, further comprising:
determining a placement or a completion of another well using the production intervals.

10. A cloud-computing apparatus comprising:
one or more processors; and
one or more memories storing instructions, component data, and time-series data, wherein
the component data represents chemical attributes measured for samples from respective production zones of one or more reservoirs, wherein the component data includes oil data, water data, and gas data, and the component data includes respective parts corresponding to measurements of samples,
the time-series data represents chemical attributes measured at a series of times for productions from a well, and
the instructions, when executed by the one or more processors, configure the cloud-computing apparatus to:
associate the respective parts the component data with times and locations at which the samples are collected;
select, based on the component data, at least one compound ratio or isotope ratio that uniquely identifies from which of the respective production zones a produced fluid originates, thereby enabling an analysis of a mixture of produced fluid originating from the respective production zones that determines production allocations from the respective production zones; and
analyze the time-series data using the at least one compound ratio or isotope ratio to determine production intervals by estimating respective contributions of the productions corresponding to the respective production zones.

11. The cloud-computing apparatus of claim 10, wherein the instructions further configure the cloud-computing apparatus to:
share, among a plurality of users, access to the component data, the time-series data, analysis tools used in selecting the at least one compound ratio or isotope ratio; and
analyze the time-series data of the productions using the at least one compound ratio or isotope ratio.

12. The cloud-computing apparatus of claim 10, wherein the instructions further configure the cloud-computing apparatus to:
use a cloud-based application to process the component data by analyzing a plurality of ratios including non-normalized (AB) ratios and normalized (A/A+B) ratios of all possible compound ratios ranking ratios according to a square of Pearson correlation, wherein
a ratio is selected as a candidate for the at least one compound ratio or isotope ratio if the ratio satisfies criteria of i) the ratio is generally constant between rock samples and the productions, ii) each compound in the ratio follows linear mixing rules, and iii) the ratio provide separation from drilling mud ratios.

13. The cloud-computing apparatus of claim 12, wherein the instructions further configure the cloud-computing apparatus to:
use the cloud-based application to analyze the time-series data of the productions using the at least one compound ratio or isotope ratio to determine the production intervals.

14. The cloud-computing apparatus of claim 10, wherein:
the component data includes chemical signatures measured from rock samples collected from the respective production zones,
the time-series data includes the chemical signatures measured from productions and is analyzed using an artificial intelligence model, and
the at least one compound ratio or isotope ratio are ratios of compounds that are generally constant for both the rock samples and the productions.

15. The cloud-computing apparatus of claim 10, wherein analyzing the time-series data to determine the production intervals by estimating the respective contributions to the productions corresponding to the respective production zones includes calculating:
$${p}_{i} = {\sum }_{j = 1}^{m} {r}_{i , j} {w}_{j} , where i = 1 , 2 , … n and n \geq m , and$$
$${\sum }_{j = 1}^{m} {w}_{j} = 1 , where 0 \leq {w}_{j} \leq 1 ,$$
wherein wⱼ is a production allocation of a j^{th} production zone, Tis is a biomarker ratio value corresponding to the j^{th} production zone and an i^{th} biomarker ratio, and pᵢ is an aggregated value of the i^{th} biomarker ratio, wherein values of the production allocations wⱼ are optimized subject to
$${\sum }_{j = 1}^{m} {w}_{j} = 1$$
to generate aggregated values of the biomarker ratios pᵢ that most closely match measured values of the at least one compound ratio or isotope ratio for the productions.

16. The cloud-computing apparatus of claim 15, wherein optimizing the values of the production allocations wⱼ o generate aggregated values of the biomarker ratios pᵢ that most closely match measured values of the at least one compound ratio or isotope ratio for the productions includes minimizing a mismatch function between produced values of the biomarker ratios pᵢ and predicted values of the biomarker ratios pᵢ, and the mismatch function is selected from the group consisting of a least squares mismatch function, a least square with range correction mismatch function, a Cauchy mismatch function, a Cauchy with range correction mismatch function, and a range corrected absolute difference mismatch function.

17. The cloud-computing apparatus of claim 10, wherein the instructions further configure the cloud-computing apparatus to:
determine a placement or a completion of another well using the production intervals.

18. A non-transitory computer-readable storage medium including instructions that when executed by a computer, cause the computer to:
store, at a cloud-computing platform, component data representing chemical attributes measured for samples from respective production zones of one or more reservoirs, wherein the component data includes oil data, water data, and gas data, the component data including respective parts corresponding to measurements of samples;
associate the respective parts the component data with times and locations at which the samples are collected;
select, at the cloud-computing platform and based on the component data, at least one compound ratio or isotope ratio that uniquely identifies from which of the respective production zones a produced fluid originates, thereby enabling an analysis of a mixture of produced fluid originating from the respective production zones that determines production allocations from the respective production zones;
store, at the cloud-computing platform, time-series data representing chemical attributes measured at a series of times for productions from a well; and
analyze, at the cloud-computing platform, the time-series data using the at least one compound ratio or isotope ratio to determine production intervals by estimating respective contributions of the productions corresponding to the respective production zones.

19. The non-transitory computer-readable storage medium of claim 18, wherein the instructions further cause the computer to:
use a cloud-based application to process the component data by analyzing a plurality of ratios including non-normalized (AB) ratios and normalized (A/A+B) ratios of all possible compound ratios ranking ratios according to a square of Pearson correlation, wherein
a ratio is selected as a candidate for the at least one compound ratio or isotope ratio if the ratios satisfies criteria of i) the ratio is generally constant between rock samples and the productions, ii) each compound in the ratio follows linear mixing rules, and iii) the ratio provide separation from drilling mud ratios.

20. The non-transitory computer-readable storage medium of claim 19, wherein the instructions further cause the computer to:
use a cloud-based application to analyze the time-series data of the productions using the at least one compound ratio or isotope ratio to determine the production intervals.
